(19) United States
(12) Patent Application Publication
(10) Pub. No.: US 2006/0143236 A1
(43) Pub. Date: Jun. 29, 2006

(54) Interactive music playlist sharing system and methods

(75) Inventor: Michael Wu, Hoboken, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Bandwidth Productions Inc., New York, NY (US)

(21) Appl. No.: 11/321,571

(22) Filed: Dec. 29, 2005

Related U.S. Application Data
(60) Provisional application No. 60/640,191, filed on Dec. 29, 2004.

(51) Int. Cl. G06F 17/00

(52) U.S. Cl. 707/104.1

(57) ABSTRACT

A community media playlist sharing system is disclosed, wherein system users can upload media playlists which are automatically converted to a standardized format, media playlists can be shared with other users of the community media playlist sharing system, users can link to other playlists and obtain media from playlists automatically from third party points of purchase, users can provide recommendations, ratings and rankings relative to other playlists by system users and receive recommendations from other users and an editorial staff, participate in social networking functions including forums, discussions, weblogs, playlist topic groups and inter-user communications based on affinity for similar playlists, create playlists manually, automatically, or in real time, and wherein system users can obtain points for participation and popularity in the system and obtain profit by meta-affiliate sharing of profit for purchases of music made through playlists submitted by that user as well as through playlist toolbars distributed to third party websites.

### BACKGROUND OF THE INVENTION

The present application claims the benefit of the filing date of U.S. Provisional Patent Application No. 60/640,191, filed Dec. 29, 2004, the disclosure of which is hereby incorporated by reference herein.

### BACKGROUND OF THE INVENTION

The present invention relates to network systems for sharing, searching, playback and rating of media playlists, such as song playlists, and more specifically relates to network relational databases and interfaces thereto for sharing, converting, categorizing, searching, ranking, and distribution of media playlists.

As the costs and convenience of distributing electronic media files drops, the need for pre-bundling media such as music in a pre-arranged “album” format diminishes. In place of the “album” format, individual users have developed personal playlists of media organized by style, mood, artist, composer, theme, and the like. These playlists can be stored in digital music players, computer music software, or burned to storage formats such as CD or DVD writable disks, non-volatile memory cards, magnetic storage media, and the like.

These individual playlists have become a pivotal way for individuals to express themselves to others, as analog “mix tapes” did in the past. Playlists, unlike analog mix tapes or present-day peer-to-peer music distribution systems, do not require that the actual media listed be conveyed with the list. Rather, the playlist is simply a data structure including some combination of media title, media album, media artist, media author, and the like, and may be provided in a standardized form such as that of the Gracenote® CDDB database or open source FreeDB database for music media playlists, or similar databases for video and for other media types. These data structures permit the open and desirable expression of creative messages through sharing of media playlists, without the need to actually copy, distribute, or perform those media works.

Various systems have been developed that take advantage of the playlist concept. Multimedia software programs such as WinAmp® from Nullsoft®/AOL®, RealPlayer® from RealNetworks®, Windows Media Player from Microsoft® Corporation, MusicMatch Jukebox® from MusicMatch®, and the like, each provide the capability of building and saving personal playlists of media files. However, these programs do not readily provide ways of sharing playlists, especially without associated distribution or sharing of actual media files.

Some Internet-based systems also employ the concept of a playlist. These online music providers and online playlist providers typically use incompatible formats for their media, making it difficult for a user to store their favorite music in a single, accessible location, making it difficult for a user to share lists of their favorite media files with friends who may use a different music provider, and making it difficult to accurately track the popularity and linkages between different media files.

Thus, what is needed is an improved system and method for community sharing, searching, ranking, reviewing, discussion and relational linking of databases of community-submitted media playlists based on user-selectable characteristics of individual media files and/or individual playlists.

### SUMMARY OF THE INVENTION

In one embodiment, a universal playlist sharing system for sharing playlists including a plurality of media works, is disclosed, comprising: a server coupled by a network to a plurality of server users, the server including: a first playlist submission module for converting a first playlist in a first proprietary format submitted by a first server user over the network via a first network protocol to a standard playlist format; a second playlist submission module for converting a second playlist in a second proprietary format submitted by a second server user over the network via a second network protocol to a standard playlist format; a playlist browsing interface module enabling the first user and the second user to share the first playlist and the second playlist in the standard playlist format over the network; and a playlist searching interface module enabling the first user and the second user to share the first playlist and the second playlist in the standard playlist format over the network.

In one embodiment, the universal playlist sharing system further comprises a universal media playback module for playing back the standard format playlists, the universal media playback server including: a third party source locator module for associating each of the media files in the playlist with one or more links to third party locations for obtaining the media files when such locations exist; a playback initiator module for initiating playback of the playlist; and a playback interface module which executes playback of each media file in the playlist according to the link provided by the third party source locator.

In one embodiment, the universal playlist sharing system further comprises: an affiliate database storing associations between the first user, a first playlist submitted by the first user, and a third party location for obtaining media files from the first playlist; and wherein the server further includes an affiliate updater module for associating a credit from the third party location to the first user upon activation of the link provided by the third party source locator to a media file in the first playlist by a second user based on the associations between the first user, a first playlist submitted by the first user, and a third party location for obtaining media files from the first playlist.

In one embodiment, the universal playlist sharing system further comprises where the playback initiator module initiates playback of the media files in the playlist upon receipt of a single user interface gesture from a system user over the network.

In one embodiment, a community media playlist relational database system is disclosed, comprising: a playlist server in communication with a database of media playlists, the media playlists each including media identification information and user identification information, the at least one playlist server connected to a network for access thereto by a plurality of system users; wherein the playlist server includes a server-provided network playlist interface module providing a front-end to the playlist server over the network, the network playlist interface module including: a playlist submission interface module for submitting media playlists to the playlist server by a system user over a network from a plurality of external media playlist formats, the playlist server recognizing the plurality of external formats and converting the submitted media playlists for inclusion in the database of media playlists, a playlist linking interface module for linking the database of media playlists to additional media information through the network playlist interface module, the playlist linking interface module further linking the database of media playlists to a plurality of points of purchase for individual media items in the media playlists of the database of media playlists; and a meta-affiliate interface module for distributing affiliate profits from at least one of the plurality of points of purchase when accessed via the playlist linking interface module to distribute at least a portion of the affiliate profits among at least one of the system users based upon media identification information, system user information, and playlist information.

In one embodiment, the community media playlist relational database system further includes: a playlist search interface module capable of at least one of searching and browsing the database of media playlists to return similar playlists or system users, based on similarity of one or more of the following inputs from a system user: media identification information, media category information, media relation information, user information, or matching of a plurality of media items on respective playlists; a playlist rating interface module for rating the database of media playlists based on the summation of a number of rankings submitted by system users; and a playlist recommendation interface module for returning lists of recommended playlists from the database of playlists to system users based on an association between a playlist selected by a system user, the results of the playlist rating interface module, and the results of the playlist search interface module.

In one embodiment, the community media playlist relational database system further includes a social networking interface module for enabling network communications between system users on the playlist network based upon one or more of the following: media identification information, media category information, media relation information, user information, or matching of a plurality of media items on respective playlists.

In one embodiment, the community media playlist relational database system further includes a real time playlist interface module for interactively building a new playlist from the playlist search interface module.

In one embodiment, the community media playlist relational database system further includes a playlist toolbar interface module for creating and serving web page code to a third party server over the network representing at least one playlist including an association between the playlist and the playlist linking interface module.

In another embodiment, a media playlist sharing system is disclosed, comprising: a web interface module for serving elements of a playlist sharing system to system users over a network from a playlist sharing server; the playlist sharing server including access to a first playlist and a second playlist, the first playlist including a first playlist name, a first set of media descriptors representing a first set of media works, and first playlist description data, and the second playlist including a second playlist name, a second set of media descriptors representing a second set of media works, and second playlist description data; and wherein the playlist server includes: a playlist submission interface module, including an automatic playlist submission interface module providing: a server-based universal playlist compatibility interface to populate the first playlist from any of a plurality of third party playlist formats, and a server-based manual playlist submission interface for populating the second playlist via the web interface module; and a social networking interface module for enabling the first system user account and second system user account to directly communicate with one another and share standard playlist format information via a network communication protocol.

In one embodiment, the media playlist sharing system further comprises a third party ordering interface module for associating with each media descriptor, representing a media work, a link to each of a plurality of third parties from which a link to obtain the media work is available; a user registration interface module for populating a first system user account and a second system user account with first user data and second user data respectively, and associating a first playlist with the first system user account and a second playlist with the second system user account, and associating a first system user account with affiliate data for at least one of the third parties from which a link to obtain at least one media work from the first playlist associated with the first system user account; and a meta-affiliate interface module for crediting purchases of media works from the first playlist via the link to third party ordering interface with the first system user account according to the affiliate data associated with the first system user account.

In one embodiment, the media playlist sharing system further comprises: a playlist browsing interface module for viewing and navigating playlists in the web interface module based on playlist name, playlist media descriptors, and playlist data; a playlist searching interface module for finding playlists via the web interface module based on playlist name, playlist media descriptors, and playlist data; a playlist ranking interface module for ordering playlists for display based on bumping of playlists by system users; and a playlist recommendation interface module for providing algorithmic recommendations for a first system user account and a first playlist.

In one embodiment, a computer readable medium storing a computer program for causing a processor, used in a data processing system controlling a media playlist sharing system, is disclosed to: supply a web-based interface to a network including a plurality of system users; provide an interface for uploading media playlists from the plurality of system users to the media playlist sharing system; associate the playlists to respective system users; associate the playlists to one or more third party providers for each of the media items on the playlists; enable the sharing of the media playlists among the plurality of system users via the web-based interface; provide network communications among the plurality of users via the web-based interface according to the content of the playlists associated with respective system users; and store affiliate associations between the system users and the third party providers; and track the stored affiliate associations of each media item on the playlist associated with a user when that media item is selected for acquisition from a third party by another user.

In one embodiment, a method for sharing media playlists including a plurality of media files among a plurality of users on a network is disclosed, comprising: uploading a first playlist from a first user to a playlist sharing server over the network, the playlist sharing server including a database, a web server, and an interface to a network including the plurality of users; uploading a second playlist from a second user to the playlist sharing server over the network; converting the first playlist and the second playlist to a standard playlist format on the playlist sharing server; storing the first playlist and the second playlist in the standard playlist format in the database associated with the playlist sharing server; associating the first playlist and the second playlist with respective media identification information, media relation information, and user information for each the playlist in the database; associating the first playlist and the second playlist with a plurality of third party media providers such that each media file in the first playlist is linked to at least one of the plurality of third party media providers that distributes that media file if any, and each media file in the second playlist is linked to at least one of the plurality of third party media providers that distributes that media file if any; and, sharing the first playlist and the second playlist with the first user and the second user via the web interface over the network.

In one embodiment, the method further comprises socially networking the first user and the second user via the web interface to permit the first user and the second user to directly communicate via a network communication protocol over the network to share a plurality of playlists based upon a particular “topic” to which the plurality of playlists relate.

In one embodiment, the method further comprises associating the first user with the at least one of the third party media providers as an affiliate; and, distributing affiliate income to the first user upon the second user obtaining a media file in the first playlist from the at least one of the third party media providers via the first playlist.

In another embodiment, a method for universally sharing playlists of media works among a plurality of users on a network via a network playlist server is disclosed, comprising: submitting a first playlist in a first proprietary format from a first user to the network playlist server over the network; converting the first playlist to a standard playlist format; submitting a second playlist in a second proprietary format from a second user to the network playlist server over the network; converting the second playlist to a standard playlist format; providing a web-based browsing interface enabling the first user and the second user to share the first playlist and the second playlist in the standard playlist format over the network; and providing a web-based searching interface enabling the first user and the second user to share the first playlist and the second playlist in the standard playlist format over the network.

In one embodiment, a method for sharing playlists of media files in a community media playlist relational database system over a network is disclosed, comprising: connecting to a network at least one playlist server including a database of media playlists, the media playlists each including media identification information and user identification information, for access thereto by a plurality of system users over the network; providing a network playlist interface for interaction between the playlist relational database system and the plurality of system users, including: submitting media playlists to the playlist server by a system user over a network from a plurality of external media playlist formats, the playlist server recognizing the plurality of external formats and converting the submitted media playlists for inclusion in the database of media playlists, and linking the database of media playlists to additional media information through the network playlist interface, the playlist linking system further linking the database of media playlists to a plurality of points of purchase for individual media items in the media playlists of the database of media playlists; and distributing affiliate profits from at least one of the plurality of points of purchase when accessed via the playlist linking interface to distribute at least a portion of the affiliate profits among at least one of the system users based upon media identification information, system user information, and playlist information.

In one embodiment, a method for sharing media playlists, including a first playlist and a second playlist, the first playlist including a first playlist name, a first set of media descriptors representing a first set of media works, and first playlist description data, comprising: providing a playlist sharing server to a plurality of system users over a network; receiving a first playlist from a first system user; automatically translating the first playlist from the first user to a standard playlist format; populating the first playlist name, first set of media descriptors, and first playlist description data based on the translated first playlist from the first user; sharing playlist data from the first playlist in the standard playlist format to a plurality of system users over a network from the playlist sharing server; and, connecting the first user and another user via a server-based social networking interface to enable the first user and another user to directly communicate with one another via a network communication protocol mediated by the playlist sharing server, based on the sharing of the first playlist between the first user and another user.

Preferably, the network community playlist sharing system further includes a playlist browsing process capable of browsing by playlist ranking, playlist category, relationship to other playlists, or media identification data.

The network community playlist sharing system may further include a playlist search process capable of returning, for a plurality of media identification data selected to be searched, a set of media playlists from the database of media playlists that include the plurality of media identification data to be searched.

The network community playlist sharing system may even further include a playlist ranking process for ranking playlists based on correlation of the actual playlist rating values for each playlist and the total number of ratings values for each playlist.

The network community playlist sharing system may further include a playlist bumping process for signifying playlist, artist, and media file popularity via a cumulative individual system user voting algorithm.

The network community playlist sharing system may further include a playlist star process for signifying a system user's most preferred playlists, artists, and media files.

The network community playlist sharing system may further include a media value recommendation process for providing recommendations of a set of one or more media values including media playlists, artists, songs, other members or media files, the process including selecting one or more source media values, cross-referencing the selected media values to other playlists created by other playlist owners on which the media values appear, cumulatively counting other media values found on the other playlists, weighing the cumulative count towards media values found on the other playlist for which those media values are selected as most preferred by each other playlist owner of each other playlist, and returning a predetermined number of the media values with the highest cumulative count values.

The network community playlist sharing system may further include a media value recommendation process for providing recommendations of a set of one or more media values including media playlists, artists, or media files, the process further including determining what media values a system user has selected as most preferred, and repeating the selecting, cross-referencing, cumulatively counting, weighing, and returning steps for each of the most preferred media values.

The network community playlist sharing system may further include a system user ranking process for ranking system users based on accumulation points associated with system user participation, system user popularity, and playlist rankings for media playlists submitted by that system user.

The network community playlist sharing system may further include a meta-affiliate system for allocating profits from affiliate transactions among one or more system users based on at least one of playlist ownership, system user ranking, and playlist ranking.

The network community playlist sharing system may further include a playlist linking system for linking media identification data, media playlists, system users, and third party information based on a combination of system-user entered information and a relational network of links between said media works, media playlists, system users, and third party information.

The network community playlist sharing system may further include a universal media playback system including a playlist with a plurality of media files, a third party source locator associated with each of the media files, a playback initiator associated with the playlist, and a playback interface which executes playback of each media file from a designated third party source location according to the third party source locator.

The network community playlist sharing system may further include a universal media playback system further including a single user interface gesture associated with the playback initiator, the single user interface gesture activating the playback initiator to signal the playback interface to execute playback of each media file in the playlist automatically without further activation of the playback initiator.

The network community playlist sharing system further including a universal playlist interoperability system comprising a first playlist in a first proprietary format, a second playlist in a second proprietary format, a first playlist delivery path for delivering the first playlist to the universal playlist interoperability system via a standard first network protocol, a second playlist delivery path for delivering the second playlist to the universal playlist interoperability system via a standard second network protocol, a first playlist converter for converting said first playlist to a standard format, a second playlist converter for converting said second playlist to a standard format, and a standard format playlist interface for interacting with said first playlist and said second playlist in said standard format.

The network community playlist system further including a universal playlist interoperability system, wherein said first network protocol is a standard electronic mail protocol.

The network community playlist system further including a universal playlist interoperability system, wherein said first network protocol is a standard electronic mail protocol.

The network community playlist sharing system further including a playlist toolbar interface generator, comprising a playlist upload interface for uploading a playlist of a plurality of media files to the interface generator from a user to the playlist sharing system, a third party store interface for selecting third party stores that provide one or more of the media files to the public to appear in the toolbar, a toolbar options interface for selecting toolbar design and options, a toolbar code interface that presents the user with toolbar code that the user may place in the code that generates another web page, a toolbar management interface for viewing, editing and deleting toolbars, and a toolbar provision interface that generates the toolbar on the another web page upon execution of the toolbar code in the source code of the another web page.

The network community playlist sharing system further including a playlist toolbar interface generator, further comprising an affiliate interface, associated with the third party store interface, for selecting affiliate codes for the user recognized by one or more of the third party stores.

The network community playlist sharing system further including a social networking playlist system, including a friend invitation interface for inviting other users to share a set of playlists each containing a plurality of media files, a playlist sharing interface for sharing the set of playlists regardless of the original format of each playlist in the set of playlists, a playlist playback interface for playing back each media file regardless of the original format of each media file in each playlist, wherein said playlist sharing interface includes security controls for limiting playlist access to a predetermined set of designated friends.

The network community playlist sharing system further including a social networking playlist system, further including an electronic mail distribution system for user discussions.

The network community playlist sharing system further including a social networking playlist system, further including a weblog engine for user discussions.

The network community playlist sharing system further including a discussion group engine for enabling discussions among a plurality of playlist sharing system users, said discussion group engine associated with one or more user-selected topics, said discussion group engine also associated with one or more playlists, wherein said discussion group interface includes security controls for limiting discussion group access to a predetermined set of users.

The network community playlist sharing system, further including a real time playlist generator, the real-time playlist generator comprising a media file selector for interactively selecting media files from a plurality of sources for inclusion in a real time playlist, a playlist manager interface for editing, deleting or adding media files and information to the real time playlist, and a playlist storage interface for converting the real time playlist to a permanent playlist in the community playlist sharing system.

### BRIEF DESCRIPTION OF THE DRAWINGS

FIG. 1 is a schematic diagram of one embodiment of a playlist database system of the present invention.

FIG. 2 shows one representational view of an embodiment of a web-based front-end to an automatic playlist submission system in accordance with the present invention.

FIG. 3 shows one representational view of an embodiment of a web-based front-end to a manual playlist submission system in accordance with the present invention.

FIG. 4 shows one representational view of an embodiment of a web-based front-end to a playlist description interface in accordance with the present invention.

FIG. 5 shows a schematic representation of an embodiment of a playlist submission system in accordance with the present invention.

FIG. 6 shows a representational view of a web-based front-end to one embodiment of a playlist browsing system including traditional music categories, context categories, playlist rankings and system user rankings in accordance with the present invention.

FIG. 7 shows representational view of a web-based front-end to a playlist browsing system including those playlists in the context category of “songs for a long trip” in accordance with the present invention.

FIG. 8 shows a representational view of a web-based front-end to one embodiment of a playlist searching system in accordance with the present invention.

FIG. 9 provides a representational view of a web-based front-end for one embodiment of a playlist ranking system, for a search for playlists.

FIG. 10 shows representational view of a web-based front-end for one embodiment of a playlist including third party links for purchase of media works listed thereon in accordance with the present invention.

FIG. 11 provides a flow chart representation of one embodiment of a single-gesture playlist playback interface.

FIG. 12 shows a representational view of a web-based front-end for one embodiment of a system user registration screen of the playlist sharing system in accordance with the present invention.

FIGS. 13-14 show a representational view of a web-based front-end for one embodiment of a customized playlist and system user status screen denoted as “MyFIQL” in the playlist sharing system in accordance with the invention, including customizable personal playlists, customizable personal playlist categories, favorite playlists, history of reviews, favorite users, and links to other system users tracking this user's playlists.

FIG. 15 provides a flow chart representation of a meta-affiliate system for system users.

FIG. 16 provides a flow chart for a web-based front-end for one embodiment of a customized playlist “bumping” system.

FIG. 17 provides a flow chart for a web-based front-end for one embodiment of a customized playlist “starring” system.

FIG. 18 provides a flow chart for a web-based embodiment of a customized playlist recommendation system wherein recommendations are provided by artist.

FIG. 19 provides a flow chart for a web-based embodiment of a customized playlist interoperability system.

FIG. 20 provides a flow chart for a web-based embodiment of a customized playlist toolbar creation and affiliate system.

FIG. 21 provides a flow chart for a web-based embodiment of a social network schema based on sharing of playlists.

FIG. 22 provides a flow chart for a web-based embodiment of a real time playlist creator.

FIG. 23 provides a representational view of a web-based embodiment of a real time playlist creator.

FIG. 24 provides a schematic view of one embodiment of a network-based playlist sharing system.

### DETAILED DESCRIPTION

The system and method of the present invention permits a network-based media community to share media playlists, such as song playlists, among community members. It also permits the uploading, categorization, ranking, linking, reviewing, and searching of media playlists. It, in addition, facilitates the purchase of media described in media playlists through a plurality of third party vendors, and provides a meta-affiliate program for distribution of profits from third party vendor affiliate programs to community members based on a variety of factors. Comparison features of the community playlist system are advantageously based on playlist to playlist, rather than the concept of albums.

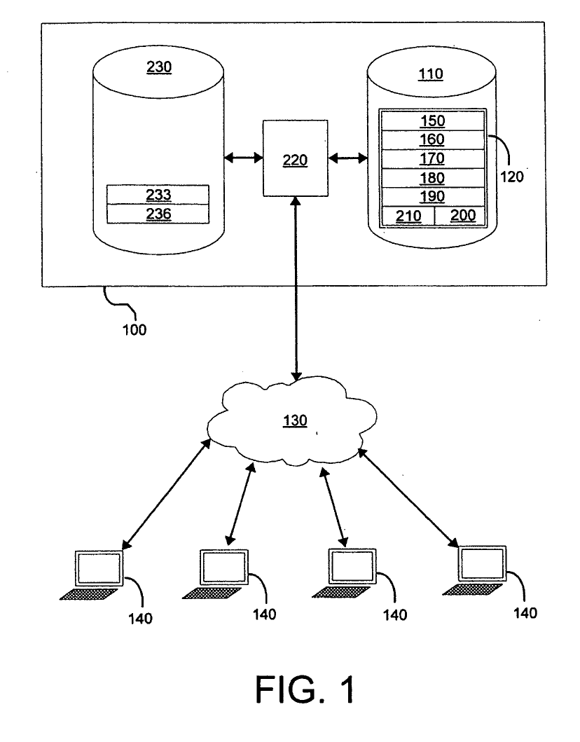

One embodiment for a network-based community media playlist sharing system in accordance with the present invention is shown in FIG. 1, and is representative of a preferred embodiment entitled “FIQL.” A central playlist server(s) 100 including one or more microprocessors, a system memory, system permanent data storage such as a hard disk drive system, a system data bus and a network input/output bus is connected to a database 110 of media playlists 120. The database 110 is preferably centrally located at the playlist server 100, but may also be distributed on a network 130, such that the database may be distributed in a peer-to-peer fashion among system users 140 or may be distributed amongst multiple servers in such a manner as to compensate for high network load or a large number of requests for access to the database (commonly known as the “Slashdot effect,” based on high loads to a website caused by links from the front page of the news site http://slashdot.org).

The database 110 is, in one embodiment, a SQL database of media playlists 120 connected directly or via a network to the playlist server 100. The media playlists 120 each include, in one embodiment, for example, for each media work 150 (which itself is shown as included as part of the playlist data but typically would not be included in a playlist dataset itself) on the media playlist 120, a set of media identification data 160, media ranking data 170, media category data 180, media linking data 190, system user data 200, and third party data 210. Each of these types of data is described in more detail below.

Third party data 210, in one embodiment, for example, includes references to third party sellers of media works 150, and in particular can include links to one or more third party uniform resource locators for purchase of a particular media work 150 that is part of a media playlist. The third party uniform resource locators may advantageously include an affiliate link reference for which the community playlist sharing system receives some portion of the purchase price for the media work 150. As described above, the community playlist sharing system can automatically determine, based on media identification data for each media work, whether that media work is available at any one of a plurality of third parties. If available, a link is stored to that third party and as such makes that media work available to a system user for legal purchase.

Media ranking data 170 includes, in one embodiment, for example, numerical values that represent relative rankings of media playlists. The media ranking data 170 is preferably provided to include not just an average of ratings given, but instead to provide a value that correlates both the substantive ratings given by system users with the number of total ratings provided by system users. In another embodiment, for example, media ranking data 170 includes user votes, or “bumps,” that are summed from a plurality of uniquely identified users to determine the relative popularity of a particular media playlist.

Media category data 180 includes, in one embodiment, for example, references to one or more pre-determined categories to which a media playlist 120 can be submitted. Such categories may include traditional music categories (jazz, rock, pop, classical, folk, urban, electronic, and the like), mood categories (rainy day, love songs, and the like), or context or lifestyle categories (songs for long drives, songs for jogging, songs for studying, songs for relaxation, songs for a date, and the like). In some embodiments, system users can create their own categories or recommend categories for creation.

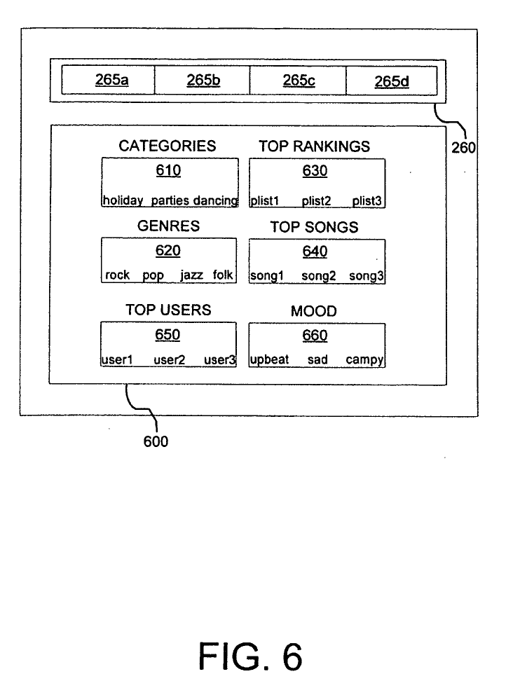

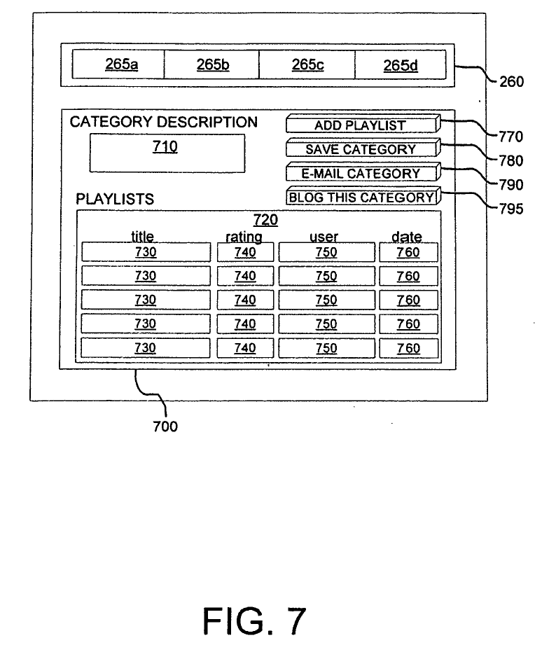

Various examples of media categories can be seen in FIG. 6 below, which includes context categories (called “FIQL Categories”) and traditional music categories, as well as top users, top songs, and top playlists. FIG. 7 below shows a list of playlists falling into a context category, in his case “songs for a long trip.”

Media linking data 190 includes, in one embodiment, for example, references such as uniform resource locators submitted by system users to information related to a media work 150, such as a song artist home page, or internal links to other playlists or other pages that relate to the media work 150. Through media linking data 190, clicking a link on a listed media work 150 or other media identifying data advantageously brings a system user to a page listing other playlists including that media work 150 or the same media identifying data.

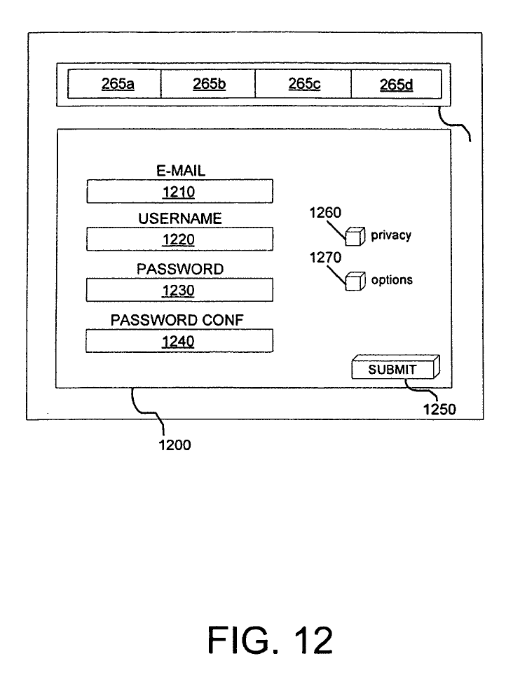

System user data 200 includes, in one embodiment, for example, information related to the identity of a system user. This information includes, for example, informational data including, without limitation, some combination of user name, e-mail address, password, playlists, user points, and user rank, starred (favorite) playlists, categories, starred (favorite) artists, songs, number of playlists created, number of playlists commented on, user ranking of playlists created, forum threads participating in, such as, for example, those submitted in a registration screen as shown in FIG. 12. After registration, a system user can log in via a login screen. Playlists are those playlists submitted by the system user and thus associated therewith. System users need not supply all of this information, but submission of this information through a registration process is available and advantageously provides additional features such as a profile page (generated by the web front-end via system user data and playlist data stored in the server), where system users can display a description of themselves and provide links to their websites. For example, a musician could link to his band's official website. The profile page automatically lists all playlists that member has contributed, via the existing playlist database and system user database information. Other information, such as an e-mail contact link, can be included if desired.

System users 140 connect to the database 110 over a network 130 such as the Internet, via a network-database interface 220, preferably provided in the form of a web-based interface. The web-based interface 220 includes a secondary database 230 of web pages 233 and scripts 236 that interactively serve pages to system users that include media playlist information from the database 110 and secondary database 230. The web-based interface 220 can be implemented using any well known web server software, such as, for example and without limitation, solutions available from the Apache project, Microsoft IIS, Netscape Server, and IBM. The web-based interface 220 and database 110 can be co-located on the same computer or on separate computers, and can share data structures or consist of separate data structures. The system users preferably interact with the playlist database 110 through a web-based interface in a manner well known to those of skill in the art of web database programming, through integration of the SQL database with the web-based interface. One preferred embodiment of web pages representing a web-based interface to the present system is described in detail below.

The media playlists 120 include information on media works 150. Media works can include, for example and without limitation, music, movies, books, pictures, video games or characters, sports figures or teams, and the like. As used herein, music files are an example type of media work. Media identification data 160 for each media work 150 includes, for example, for a musical work, information such as but not limited to song title/track, song artist, song album, and song genre. Other types of information may also be included, such as, for example, album graphics, song label, song copyright information, and the like. The playlist submission and extraction process is described in more detail below

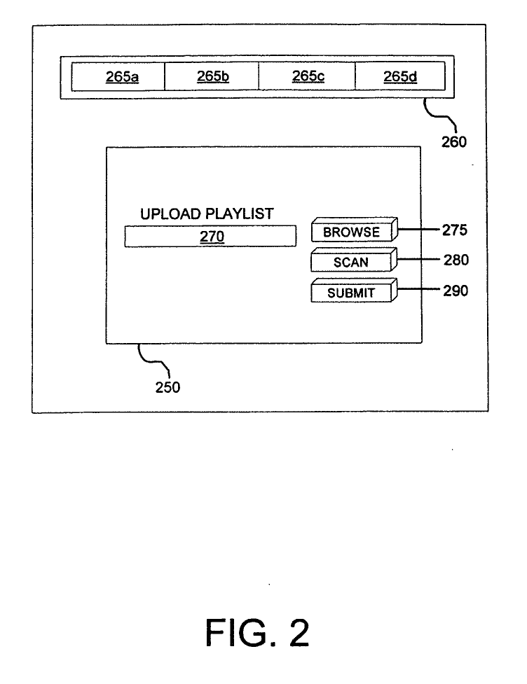

FIG. 2 shows one representational view of an embodiment of a web-based front-end to an automatic playlist submission system in accordance with the present invention. The community playlist system uses a playlist submission system to import playlists from a number of different media playlist formats, including music players such as, for example and without limitation, AOL/Nullsoft Winamp®, Apple® iTunes®, Windows Media Player®, RealNetworks® Rhapsody® and MusicMatch® Jukebox. The automatic playlist submission system includes an automatic playlist submission window 250, in which a system user 140 can manually enter a playlist file for uploading into the system. The submission window 250 advantageously includes a menu bar 260 including a plurality of options 265a, 265b, 265c and 265d for navigating the playlist sharing system. In one embodiment, the plurality of options 265a-d include web hyperlinks to the system homepage, the playlist submission interface, a playlist browsing interface, options, discussion boards, user registration, search functions, and the like. A file submission box 270 is provided for entering the name of a playlist file local to the user. A browse button 275, such as that provided by standard operating system APIs, is provided to permit the user to browse the local file system for a particular playlist file to upload. A scan button 280 is provided (described in more detail below), to permit the automatic playlist submission system to scan the user's local file system for recognized playlist files based on file extension or metadata (such as an *.m3u extension and the like), wherefrom the user can select one or more of the found playlists for uploading to the system. Once a playlist has been selected for uploading to the system, a submit button 290 is provided for the user to actually upload the playlist to the system. After the system user submits a playlist via the music submission window, the user can associate the playlist to one or more specific music genres, music categories (playlists suited for a situation such as, for example, a birthday party), or both, and can edit their playlist content. In addition, system users can create their own music categories.

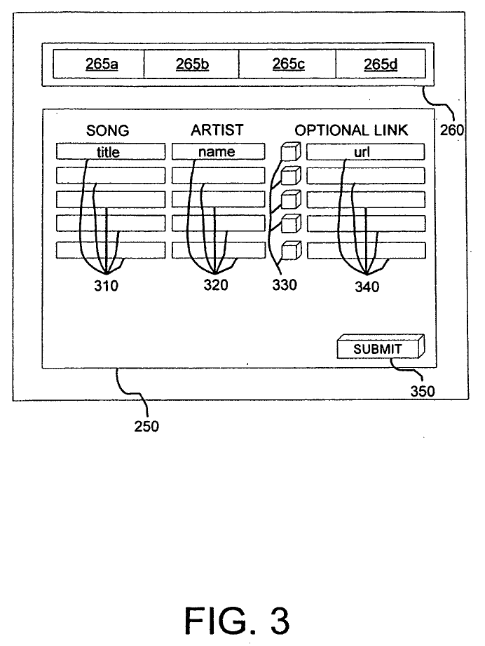

FIG. 3 shows one representational view of an embodiment of another web-based front-end for a manual playlist submission system in accordance with the present invention. The manual playlist entry interface screen 300 includes a menu 260 and submenus 265a-d as described above. For each media item the user seeks to enter (in this case a song), a song entry block 310, an artist name entry block 320, an optional link designation button 330, and an optional link uniform resource locator 340 for submitting a link to further external resources related to the media work. If a system user submitting a playlist has indicated that a song is from an independent artist, a uniform resource locator to a website with information about that band or artist can be included. The community playlist sharing system automatically stores this link as a third party data link and makes that link clickable and available to all system users once the playlist is processed.

Once the user has submitted information for all respective songs, the information can be submitted via a submit button 350. In some embodiments, the manual playlist submission interface screen 300 can be combined with the playlist description screen 400, described below.

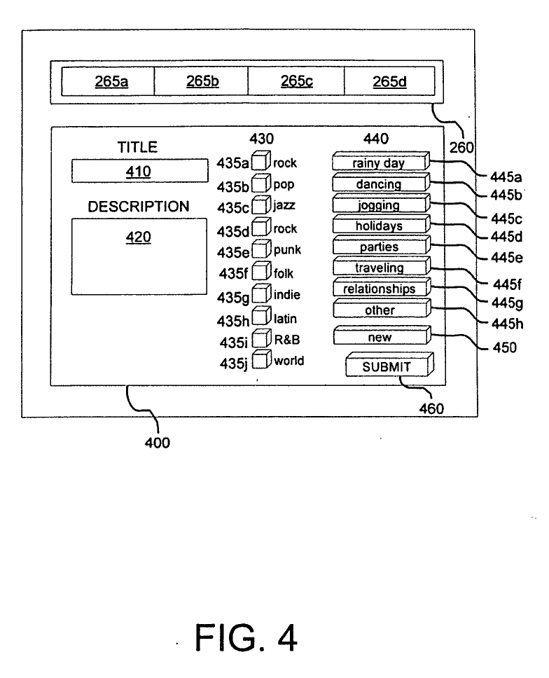

FIG. 4 shows one representational view of an embodiment of another web-based front-end for a playlist description interface screen 400. Beyond the standard menu 260 and submenus 265a-d, a playlist title block 410 and a playlist description block 420 are provided for titling and providing a textual explanation of the playlist. In addition, the user can select one or more (in one embodiment, preferably about five) music genres for the music in the playlist from a checkbox list 430 of playlist categories, for example and without limitation, categories 435a-j. Similarly, the user can select one or more (in one embodiment preferably up to five) lifestyle categories 440 from a set of press-button menus, for example and without limitation, categories 445a -h for some lifestyle categories, or a user can mix and match a number of (in one embodiment, preferably up to five) lifestyle categories and music genres. Furthermore, in one alternative embodiment, although not preferred, optionally the user can create a new lifestyle category for the playlist via a new category selection button 450. Finally, the user can submit the completed playlist to the playlist sharing system via a playlist submission button 460.

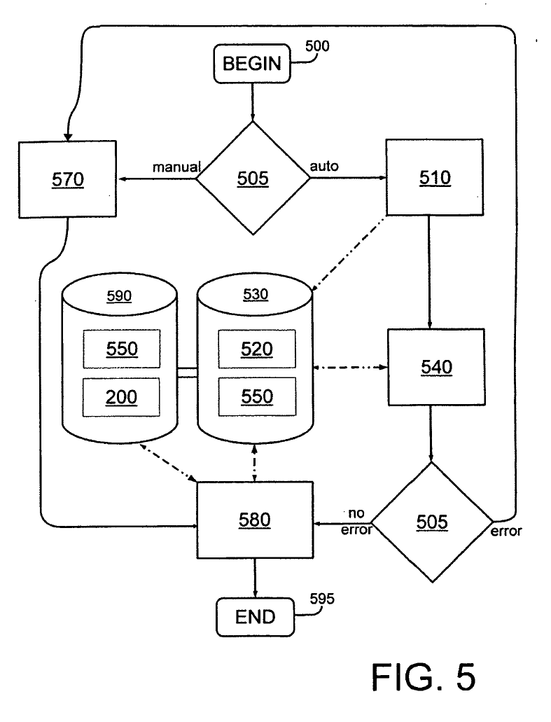

FIG. 5 provides a schematic view of one embodiment of the playlist uploading interface. A system user, associated with system user data 200, enters the playlist submission interface 500 with an automatic playlist submission decision block 505. If the user selects automatic playlist submission, then an automatic playlist file submission block 510 is selected, such as the automatic playlist upload interface of FIG. 2, resulting in temporary storage of an uploaded playlist file 520 in temporary storage 530. The uploaded playlist file 520 then enters a conversion block 540 where the uploaded playlist file 520 is converted in to a standard playlist file 550 kept in temporary storage 530. In the event that the conversion block 540 encounters an error, the error handler 560 the user is forwarded to the manual playlist submission block 570 for manual submission of playlist information, as shown in FIG. 3.

As part of the automatic playlist submission process, the community playlist sharing system extracts playlist information from a variety of playlist formats submitted by end-users. This extraction/conversion process is performed upon uploading of a playlist by a system user, and requires no interaction or steps to be taken by the system user to convert the playlist prior to uploading it to the community playlist sharing system. For example, Appendices I and II include examples of software scripts that automatically extract song titles and artist information from playlists created by popular music players such as, for example, (Appendix I) Windows Media Player®, (Appendix I) Winamp®, RealNetworks® Rhapsody®, and iTunes® (Appendix II). This converted information is stored in the media playlist database in a standard playlist format.

If no error occurs in the conversion block 540, then the user enters playlist description data in the additional playlist information block 580, as shown in one embodiment in FIG. 4, and the resulting information updates the standard playlist file 550. The completed standard playlist file 550 is then placed in the main playlist database 590, and is associated with the individual user via the user data 200.

If the user selects manual playlist submission at the automatic playlist submission decision block 510, or the user is transferred to manual playlist submission from the error handler 560 then a manual playlist file submission block 570 is provided, as for example seen in the embodiment of FIG. 3, for manual submission of playlist data. Then, additional playlist information is submitted in the additional information playlist interface block 580. Once all information is submitted, the completed standard playlist file 550 is then processed and placed in the main playlist database 590, and is associated with the individual user via the user data 200.

As media playlists are submitted to the community playlist sharing system, they are processed to add features useful to all system users, as described in detail below.

FIG. 6 shows a representational view of an web-based front-end to one embodiment of a playlist browsing system including traditional music categories, context categories, playlist rankings and system user rankings in accordance with the present invention. A playlist sharing system browsing interface 600 includes a standard menu 260 and submenus 265a-d as described previously. The browsing interface 600 in one example includes links for browsing playlists by lifestyle categories 610, by music genres 620, by top ranked playlists 630 according to the playlist ranking system described below, by top ranked songs 640 according to the ranking system described below, by top ranked system users 650 according to the user scoring system described below, or for further non-limiting example, the interface 600 may advantageously include lists sorted by most recently submitted, most recently bumped, must recently commented on, most bumped, most commented on, most viewed, and for further example, and by the mood 660 of the media on each playlist.

FIG. 7 shows representational view of a web-based front-end to a playlist browsing system including those playlists in the context category of “songs for a long trip” in accordance with the present invention. The playlists in this category were preferably so placed according to the playlist uploading interface described in FIGS. 2-5 above.

The playlist browsing context category interface 700 includes specific information related to the playlists in this category including a category description 710, links to individual playlists in this category 720, and information regarding those playlists including title 730, their rating or “bump” level 740, the name of the system user 750 who created the playlist, and the playlist date 760. In addition, a system user can submit their own playlist to this category through an add playlist link 770, can save this category to the system user's personal preferences via a save category link 780, or can e-mail this category of playlists via an e-mail category link 790. In addition, in one embodiment a selection button is presented for a user to “blog this playlist” whereby, upon selection of the “blog this playlist” button 795 for a particular playlist, one line of blog code is provided to the user from which the user can present the playlist on a third party weblog or web site, similar to the playlist toolbar function described in detail below.

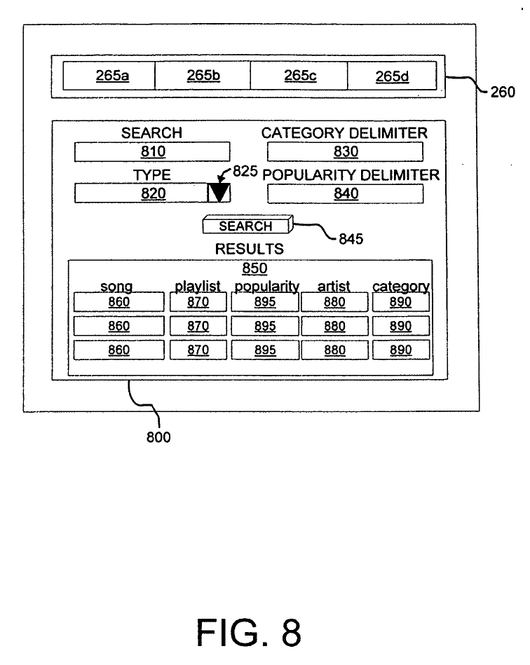

FIG. 8 shows a representational view of a web-based front-end to one embodiment of a playlist searching system in accordance with the present invention. A search interface window 800 includes a standard menu 260 and submenus 260a-f. A primary search box 810 is provided for a user to enter a search string, and a search type box 820 is provided for a user to select the playlist field to search (such as, for example, song, title, artist, and the like). In one embodiment, the search type box 820 includes a pull-down selector 825 for selecting field type from a list. A search limiter box 830 is provided for a user to limit the search to a particular part of the playlist database such as a particularly playlist category or playlist genre. A rating or popularity limiter box 840 is provided for a user to limit the search to playlist results with a certain minimum rating, popularity, or minimum bump level, as described in more detail below. A search button 845 is provided for executing the search function. Finally, a search results box 850 provides playlists that include the search results string therein, including fields for matching song 860, matching playlist 870, matching artist 880, matching categories 890, and playlist rating, popularity, or bump level 895.

In this manner, all songs titles and artist names are individually linked to pre-formed search queries in the main playlist database 590 that allow system users to find other playlists with these songs or artists with one click. In addition, a list of “similar” playlists can be returned. This is done by matching songs in one playlist to songs in other playlists and setting a threshold of similarity through standard SQL database commands (such as a specific percentage of matching songs), or a via a weighted search process as described in more detail below.

The community playlist sharing system also advantageously includes a music matcher feature that allows system users to enter up to five songs and/or artists then returns a list of playlists that most closely matches this set up music interests. System users can also search by various types of media identification information, or playlist information such as song, artist, playlist name or description. Such a search system is shown in FIG. 8, where matching results are returned for a search.

Just as a system user can search playlists, a user can select a set of media identification information or playlist information, such as song or artist, and search for other system users that have submitted playlists containing that set of information (or that closely match that set of information). For example, a first system user can enter a set of five songs, and based on those five song names, a list of system users including those five songs on their playlists is returned. For further example, an automated list of the most similar system users can be created by such a process, by comparing and linking system users by increasing similarity of playlists. In this manner, the playlist sharing system can serve as a social networking tool.

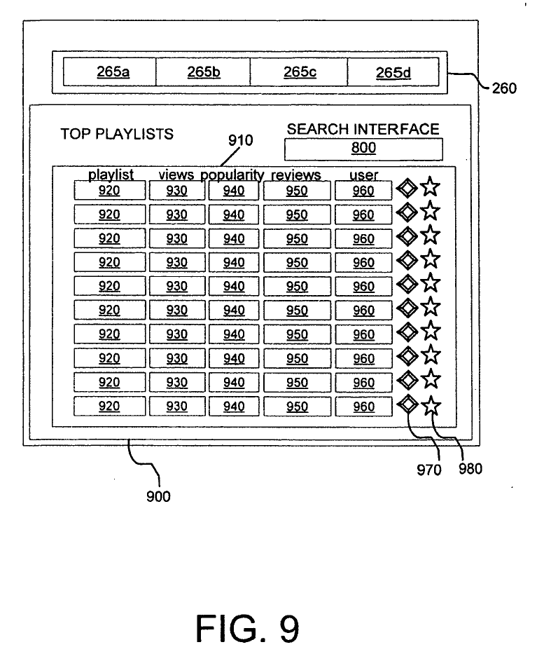

FIG. 9 provides a representational view of a web-based front-end for one embodiment of a playlist ranking system, for a search for playlists. In this manner, user can provide a simple “bump” to a media playlist to permit a user to mark the playlist for recognition from the playlist sharing community. As unique users each bump particular playlists, the playlists with more bumps are ranked more highly in the playlist sharing system. A simple tally of user “bumps” for each playlist is kept with the standard playlist file in the main playlist database, such that playlists with the most bumps can be readily extracted and listed for any particular category, genre, artist, song, and the like, using standard database query commands.

A playlist ranking window 900 is shown with a standard menu 260 and submenus 265a-d. A list of the top-ten playlists is provided in a ranking list 910. For each top ranked playlist, the playlist name 920, number of playlist views 930, number of playlist “bumps” 940, number of reviews 950, and the system user 960 who created the playlist, are listed. Moreover, the search interface, as described in FIG. 8, can be applied to the playlist ranking interface 900 in order to view top ranked playlists in any particular subset of playlists. For each playlist name 920 on the ranking list 910, a number of button options are also advantageously provided. For example, in one embodiment a “blog this playlist” button 970 is provided which provides the user with a text link to the playlist that can be posted to the user's or another third party website. As another example, a user can “star” a playlist via the star button 980, through which the user designates the playlist as one of the user's favorite playlists. As further discussed below, “starred” playlists can be tracked and can appear on the user's personalized pages of the playlist sharing system.

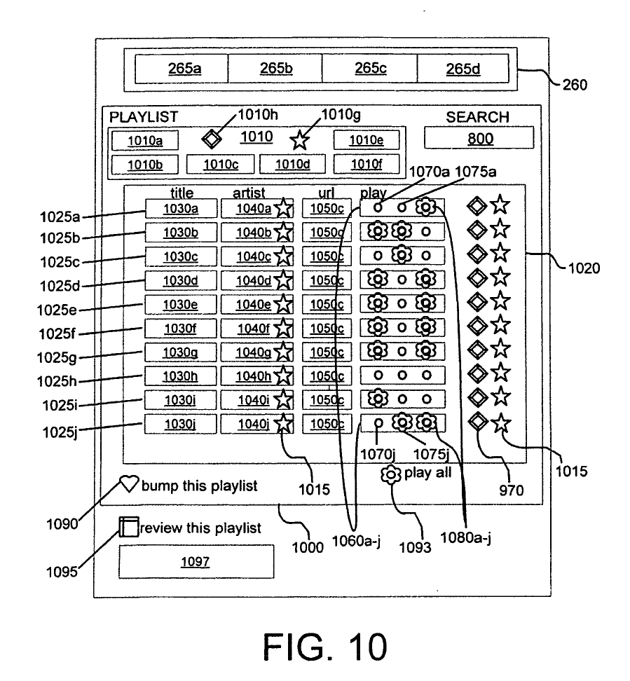

Generally, if a system user “bumps” a playlist in the playlist sharing system via a “bump” link (described below in FIG. 10), then an additional bump is added to the playlist's ranking and the playlist will appear higher on the ranking list of playlists returned for particular searches or browsing requests to the playlist sharing system.

Alternatively, a more complex playlist ranking system can be used. Many existing rating systems rely entirely too much on the average rating. Whereas existing systems will rate an item with a single “5” rating (i.e., only one person has rated the item as a “5”) above another item with twenty “4” ratings (i.e., twenty people have rated the item as a “4”), the present system is configured to take into account the large number of “4” ratings relative to the single “5” rating, and to adjust a final “ranking” from these relative values. The large number of ratings itself is an indicator of value for the playlist, and is not taken into account by ordinary “average” ratings systems. In particular, the playlist rating system also takes into account both rating and the number of ratings and rewards playlists more for getting higher ratings and penalizes them for lower ratings. In one preferred embodiment, once a minimum number of ratings have been given to a playlist (in one embodiment, a minimum of five), then playlist rankings can be determined via the following formula:

$${T}_{score} = {\sum }_{n} ( {R}_{n} - {R}_{avg} ) \qquad ( Eq . 1 )$$

where T_{score} is the total score for a particular playlist, n is the number of ratings given for a particular playlist, Rₙ is the nth rating given, and R_{avg} is the average integer rating available. For example, on a 1 to 10 ratings scale, R_{avg} is 5. For a 1 to 4 scale, R_{avg} is 2. In this manner, total score accumulates with positive ratings and decreases with negative ratings, providing a means for determining a final ranking based on both the qualitative values assigned to a playlist and the quantitative number of ratings provided for that playlist.

Rankings are based first on their score, then their average rating. Every time a playlist is rated it earns points (or loses points) towards a total score. The point values for each rating are listed in the table below. A playlist must have at least a given number of reviews (e.g., five reviews) before it can be entered into the ranking system (e.g., the top five playlists that appear on the homepage. The rank of popular playlists is then calculated by comparing the total scores for all playlists with, in one embodiment, more than five ratings. One preferred embodiment for calculating total scores in a 1 to 10 point system is shown in Table 1. A preferred embodiment for determining total scores and final rankings for each media playlist based on a string of ratings is shown in Table 2.

TABLE 1

| Ratings | Points |
|---|---|
| 1 | −4 |
| 2 | −3 |
| 3 | −2 |
| 4 | −1 |
| 5 | 0 |
| 6 | 1 |
| 7 | 2 |
| 8 | 3 |
| 9 | 4 |
| 10 | 5 |

TABLE 2

| | Average | Total | Final |
|---|---|---|---|
| Media Playlist Ratings | Rating | Score | Rank |
| 3, 4, 4, 6, 7 | 4.8 | −2 | 5 |
| 7, 6, 5 | 6.0 | 3 | — |
| 10, 1 | 5.0 | 1 | — |
| 6, 7, 8, 6, 4, 8, 9, 6, 8, 10, 9, 7, 6, 5, 8, 4 | 6.9 | 31 | 1 |
| 6, 7, 4, 5, 7 | 5.8 | 4 | 3 |
| 10, 10, 9, 8, 7 | 8.8 | 19 | 2 |
| 10, 2, 3, 4, 6, 4, 5, 4, 5, 4, 3, 6, 7, 5, 5, 5, 4, 5, 6 | 4.9 | −2 | 4 |

Note that in the example of Table 2, the playlist with and 8.8 average rating is ranked below the playlist with a 6.9 average rating. The playlist with the 6.9 average rating also has many more reviews. If the 8.8 playlist keeps its pace, it will out rank the 6.9 playlist in short time. Exemplary code for playlist ratings and rankings is provided in Appendix III.

In addition to the rating and ranking system shown above, system users can also provide written detailed reviews of a playlist and/or a system user to provide more detailed opinions to other system users.

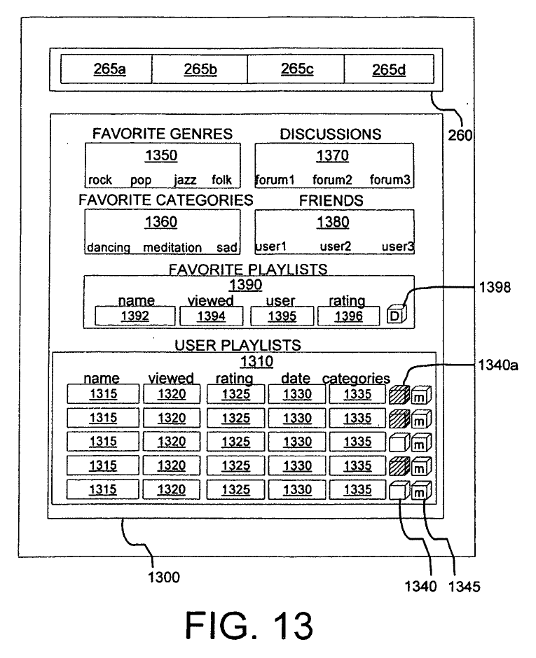

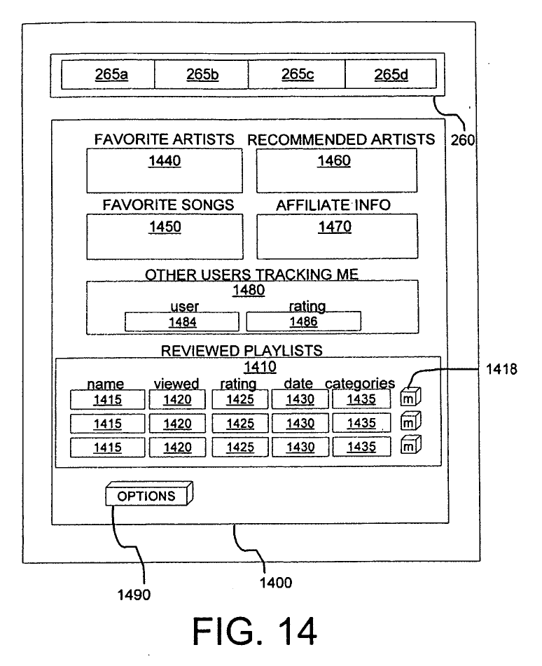

FIG. 10 shows representational view of a web-based front-end for one embodiment of a playlist viewing interface including bump-based ratings and third party links for purchase of media works listed thereon in accordance with the present invention. When a particular playlist is selected for viewing from the main playlist database, a playlist viewing screen 1000 is provided with a standard menu 260 and submenus 265a-d. Playlist identification information 1010 is displayed, and typically includes the information including playlist title 1010a, playlist date 1010b, playlist bump level 1010c or rating, number of playlist reviews 1010d, number of playlist views 1010e, and current categories 1010f in which the playlist exists. A system user can select the playlist, the category, an artist, a song or a system user as a “favorite” by “starring” them via selection of the “star” button 1015 associated next to each respective item, such as, for example, for the playlist itself (1010g), or for each song or artist (1015). Upon “starring” an item, it will then appear on the system user's custom user interface screen, described below with respect to FIGS. 13 and 14.

The playlist 1020 itself is displayed, preferably in a grid format, with, for each media item, 1025a-f, the media title 1030a-f, the media artist 1040a-f, an optional artist hyperlink 1050a-f, and a set of third party purchase links 1060a-f, which display individual links to purchase or listen to media works at one or more third party media providers, in this case at three media providers, represented by links 1070a-f, 1075a-f and 1080a-f. Each link is displayed as active if a particular media item 1020a-f is available from the third party music store (for example, links 1070b, 1080a and 1080j are active), and the links are not active for media works that are not available from each store (for example, links 1070a, 1070j and 1075a are shown as not active in FIG. 10). Links are made active by the playlist sharing system checking individual media items against the library of media items available at or from each of the third party providers, and storing a link to the third party point of purchase associated with each media work for each provider where the work is available.

More specifically, for music playlists all songs on the playlists are individually checked against third party systems for availability for music purchase, including, for example, iTunes® MSN® Music, RealNetworks® Rhapsody®, Buy.com, and Walmart® Music. If the song is available, a direct uniform resource locator link is stored as a third party data link associated with the standard playlist file and is provided for system users when the playlist is viewed. Moreover, for systems capable of playback of music from multiple providers, a link to play the entire playlist from one or more sources may also be advantageously provided. Such automated third party purchase links are shown and described in more detail below.

A “bump” link 1090 is provided for a system user to highlight the playlist to the playlist sharing community, if desired. If a system user “bumps” the playlist via the “bump” link 1090, then an additional bump is added to the playlist's ranking and the playlist will appear higher on the list of playlists returned for particular searches or browsing requests to the playlist sharing system. In addition, a “review” link 1095 is provided through which a system user can provide text comments for others about the playlist. Existing reviews 1097 appear below the playlist for system users to read.

In addition, a “play all” link 1093 is advantageously provided to play all songs on the playlist from one or more third party providers. This “play all” link permits all media files 1020a-f that are available from one or more third parties to be played with a single click. In one embodiment, those media files 1020a-f that are available from an interoperable media system (such as the Rhapsody service, for example) are all played. In another embodiment, any media file 1020a-f that is available from one or more music stores for which the system user has an account that is linked from their user data 200 on the playlist sharing system is played in order from each third party source respectively. In addition, although not shown in FIG. 10, in one embodiment, buttons are provided for e-mailing a playlist, saving a playlist, blogging a playlist and printing a playlist in a manner similar to that shown for categories in FIG. 7.

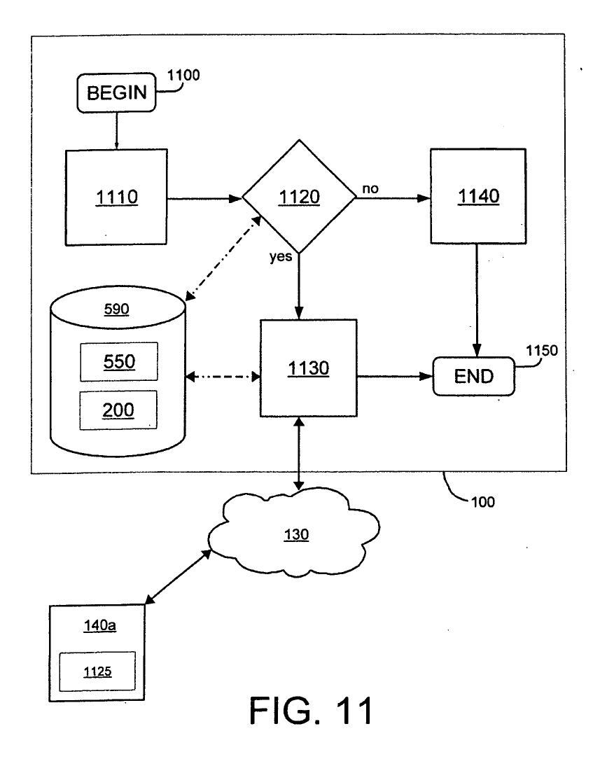

FIG. 11 provides a flow chart representation of one embodiment of the “play all” methodology. Upon clicking on the “play all” link 1093 from FIG. 10, a single-gesture playback interface 1100 is initiated. An interoperable player query 1120 is executed: by querying user data 200, the query 1120 determines whether a user 140a has a local computer with an interoperable media player 1125. If yes, then a selected playlist 550 is packaged in an interoperable packaging step 1130 for the interoperable player 1125, and is transmitted over the network 130 to the computer with the interoperable player 1125 associated with the system user 140a for playback for the system user 140a, and the process ends 1150. If the query 1120 finds no interoperable player 1125, then an error handler 1140 returns an error message or, alternatively, forwards the process to an alternative playback path, and then the process ends 1150.

If no interoperable player is found, then, optionally, in an alternative embodiment, the single-gesture playback interface determines what non-interoperable players and third party music providers are associated with the system user data. In particular, the single-gesture playback interface determines whether the system user data for the system user contains purchase and playback information for each of the third party music providers. If such data is stored for the system user, then, in the order designated in the playlist, the single-gesture playback interface then automatically traverses the playlist via a playlist traversal block, and, for each playlist song, the single-gesture playback interface performs a third party handshake block, in which it determines whether the non-interoperable players already have a copy of the song locally in a local song check block. If so, the song is played via a song playback block and the playlist traversal block moves to the next song. If not, then the third party handshake block attempts to acquire the song from the third party music providers via the local non-interoperable players via a song acquisition block. If the acquisition of the song is successful, the song is played via the song playback block and the playlist traversal block 1160 moves to the next song. If not, then the playlist traversal block simply moves to the next song.

FIG. 12 shows a representational view of one embodiment of such a web-based front-end for a system user registration screen of the playlist sharing system in accordance with the present invention, which permits customization of the playlist sharing system for the end-user. This permits registered system users to have additional powerful tools at their disposal, such as automatic one-click playback of entire playlists (even if individual songs are from different song providers), storage of personal playlists, interaction with other users, centralized storage of user affiliate information for multiple third party music providers, “bumping” good playlists to higher playlist ratings, and obtaining user rankings, via a customized web-front end systems that stores the end user's personal preferences, including system user data 200, regarding playlists, user rankings, third party music providers, and individual contact information. A registration interface screen 1200 includes a standard menu 260 and submenus 265a-d, along with an e-mail entry block 1210, a username entry block 1220, a password entry block 1230 and a password confirmation entry block 1240. The user can than submit this information via a submission button 1250. Other options can be provided at the initial registration phase, including a privacy checkbutton 1260 which permits or blocks e-mail from other playlist sharing system users.

FIG. 13 shows a representational view of a web-based front-end for one embodiment of a customized playlist and system user status screen in the playlist sharing system in accordance with the invention, including customizable personal playlists, customizable personal playlist categories, and favorite playlists. In one embodiment, this is a custom web interface called “myFIQL.” A user status interface screen 1300 includes, for example, in one embodiment, a list of the system user's own playlists list 1310, a list of favorite media genres 1350 and media or lifestyle categories 1360 as selected by the system user, a list of discussions 1370 in which the user is participating, a list of friends 1380, other users that the user selects as friends, and a list of the user's favorite playlists 1390 created by other users. The user's own playlists list 1310 includes, for each playlist, the playlist name 1315, the number of times each playlist it has been viewed 1320, the “bump” level (or popularity or rating) 1325, the date created 1330, the categories for the playlist 1335, an approval mark 1340 on whether the playlist was approved for inclusion in the main playlist database, which is highlighted as approved 1340a when a playlist has been approved for inclusion in the system (if the staff of the playlist sharing system chooses to individually approve playlists for inclusion in the system when they are submitted), and a modification button 1345 for the system user to modify each playlist using the manual playlist upload interface described previously. The favorite genres list 1350 includes, for example, media genres “starred” by the user when browsing the playlist sharing system. Similarly, the favorite categories list 1360 includes lifestyle categories “starred” by the user when browsing the playlist sharing system. The discussions list 1370 shows discussions in which the user is participating, and the friends list 1380 shows the status of other system users that this user has designated as “friends.” The favorite playlists list 1390 includes playlists created by other users that this user has “starred” as his or her favorite, where for each playlist there is included the playlist name 1392, system user who created the playlist 1394, number of playlist views 1395, playlist “bump” or rating level 1396, and a delete link 1398 to delete the playlist from the favorites list.

FIG. 14 shows a representational view of a web-based front-end for one embodiment of a customized playlist and system user status screen in the playlist sharing system in accordance with the invention, including history of reviews, favorite users, and links to other system users tracking this user's playlists. The second personalized user interface screen 1400, which may be combined with the first user interface screen 1300, includes a list of playlists commented on 1410 (playlists for which this user submitted a review) is provided. For each reviewed playlist, the playlist name 1415, number of views 1420, playlist rating 1425, playlist date 1430, playlist categories 1435, and a link to modify the review 1418 is provided in one embodiment. In addition and for example, a list of the system user's favorite artists 1440, favorite songs 1450, user points earned 1460, and affiliate information 1470 related to affiliate relationships to third party media providers, described below. In addition, a list of other system users who are tracking the user's playlists 1480 is provided, including the user name 1484 and other user information 1486. List of favorite playlists, categories, artists, and songs may be adjustably provided in this manner, such that various combinations of personalized playlist, artist, song, user, and discussion information may be provided to the user. In one embodiment, a playlist, category, artist, song, or system user can be added to a system user's custom favorites list by “starring” that item from elsewhere within the playlist sharing system, or by manually searching for and selecting items to be added to the favorites list according to a search interface block 800. A user options button 1490 may be advantageously provided so as to permit the user to modify system user data 200 settings, or modify the layout of the personalized user status screens 1300 and 1400.

Registered users can thus save playlists, categories, and links to other registered system users. Registered system users can also manage their own playlists and create and manage personalized playlist categories. Registered system members can also review their current point total and ranking. Thus, in one embodiment known as MyFIQL registered system users can save playlists, categories, other members as well as manage their own playlists and FIQL categories.

Through such linked, individually developed playlists and individual system user profiles, individuals can develop musical interest networks and social networks based on similar musical interests. Reciprocally, statistical data based on correlations between system users, music playlists, and links between playlist networks and social networks can provide valuable demographic data.

Registered system users can also review current point totals and ranking. Ratings points advantageously reward more active system users with points that indicate status in the community. Points are rewarded according to certain actions related to popularity, and certain actions related to participation, in the playlist sharing community. In one embodiment, for example, points are given based on actions and rules set down in Table 3, and exemplary code for system user ratings are shown in Appendix IV.

TABLE 3

| | PTS | Rules |
|---|---|---|
| Popularity points | | |
| Having a ‘top-5’ rated | 150 | Once per playlist |
| playlist: | | |
| Adding a successful | 75 | “Successful” = beats |
| category: | | expiration date for category |
| | | if no playlists are added |
| Each positive rating given | 5 | “Positive” = receipt of |
| to playlist: | | “bumps” within a |
| | | predetermined time window |
| Each time playlist is | 5 | |
| saved by someone: | | |
| Each time user saved by | 5 | |
| someone: | | |
| Participation points | | |
| Submitting a playlist: | 20 | Awarded after approval |
| Reviewing a playlist: | 10 | Awarded after approval |
| Posting a message on the | 5 | |
| board: | | |
| Each time logging in: | 5 | Award only once per 6 hour |
| | | period |
| Clicking a purchase link | 5 | 5 pts. for ever 5 links |
| (x5) | | clicked (no single pts.) |
| Emailing a playlist or | 5 | |
| category: | | |

Based on their point levels, system users may be given a user rank. System users who have achieved certain ranking levels will be given additional benefits, as exemplified in the example of Table 4.

TABLE 4

| Points | User Rank |
|---|---|
| 5-500 | Beginning Level |
| 505-1000 | Medium Level |
| 1005-5000 | Expert Level |
| 5000+ | Super Level |

In this manner, the community playlist sharing system gives voice to the millions of music enthusiasts in a manner unavailable in other forums or environments. System users thus mutually rate and review each other's playlists. System users earn points for participating in the community playlist sharing system by doing such things as submitting playlists, reviewing playlists, and posting messages, as shown in Tale. As their points increase, so does their ranking and prestige in the community. Additionally, the top ranked system users may obtain substantial deference to opinions and ratings given based on feedback, points, and rankings earned.

The community playlist sharing system quickly associates a system user's pre-existing music tastes with new music via categories and similar playlists. Popular playlists move to the top of the community playlist system via a rating/review system described above, and system users are rewarded for submitting playlists that are popular and/or highly rated by other members via the system user point system described above. Examples of such browsing processes are shown in FIGS. 6 and 7.

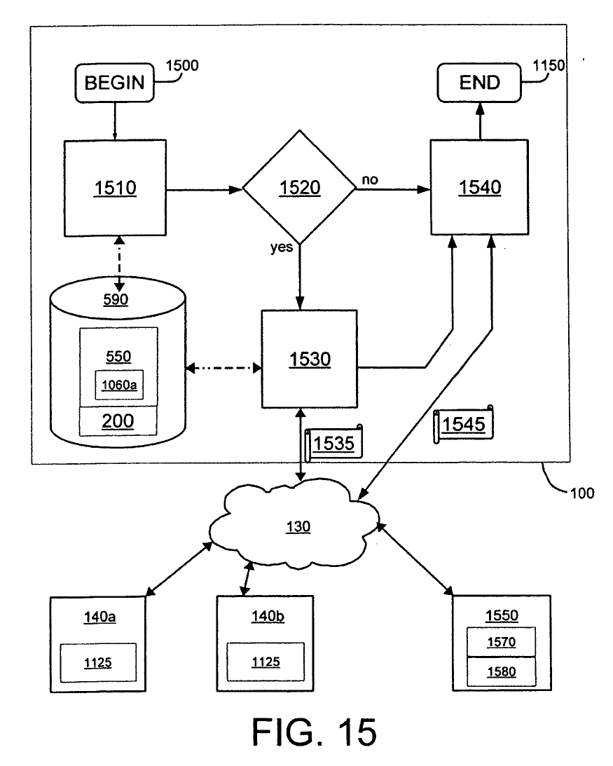

FIG. 15 provides a flow chart representation of a meta-affiliate system for system users. As an incentive and reward for system users to upload playlists, the present invention can award commissions to system users for every media work sold from a playlists they created, via a multi-level affiliate system. A media work is purchased when a system user (registered or unregistered) clicks on a third party link for purchasing a media work associated with a media work within a playlist linked to a particular registered system user.

Some online music stores give the system an affiliate commission for every song that is sold. The playlist sharing system in turn can give a portion of the commission to the registered system user who created the playlist from which the song was sold. This meta-affiliate system advantageously further can apply to the sale of entire playlists. Moreover, the amount of a commission forwarded to the registered user can advantageously be varied based on the system user ranking, playlist ranking, or number of sales of that particular media work.

A meta-affiliate interface begins 1500 when a music purchase occurs via a third party music store link 1060a for a particular playlist 1015 linked to a particular system user 140 via system user data 200. (See FIG. 10.) Specifically, when a request to purchase a media work occurs from a system user 140a, first a media purchase data reference step 1510 occurs where the meta-affiliate interface obtains from the main playlist database 590, the name of the media work to be obtained, a link 1060a to the third party, the playlist 550, the system data 200 for a second system user 140b who created the playlist, and, optionally in some embodiments, any affiliate data related to that second system user 140b. In a meta-affiliate query step 1520, the interface determines whether the second system user 140b who created the playlist has an affiliate relationship set up directly through the playlist sharing server itself or, in some embodiments, with a third party media provider 1550 according to system user data 200. If so, then the process proceeds to a meta-affiliate confirmation step 1530 whereupon meta-affiliate data 1535 is communicated, via the network 130, to the third party media provider 1550. The third party 1550 can use its own affiliate data 1580 to communicate directly over the network 130 with the system user 140b to register an affiliate credit in any manner selected by the third party 1550 and the second system user 140b, or the third party media provider 1550 can relay information back to the playlist sharing server via meta-affiliate confirmation step 1530 for storage of affiliate information with the playlist sharing server itself, wherein the system user data 200 for the second system user 140b is updated by the playlist sharing server rather than by the third party provider. At the completion of the meta-affiliate confirmation step 1530, or if the meta-affiliate query step 1520 finds no affiliate relationship, then the process moves to the media delivery step 1540. At the media delivery step 1540, based on the third party link 1060a, media request data 1545 is sent over the network 130 to the third party media provider 1550 to request a media work 1570 to be delivered to the first system user 140a. The affiliate credit to the system user can be a monetary credit as forwarded from the third party music store, a predetermined percentage of the monetary credit forwarded from the third party music store, or alternatively the credit can be converted to user points or non-monetary credit towards purchases of music or other media items. The monetary or non-monetary credit can be stored in a well known SQL database form stored with the system user's data 200.

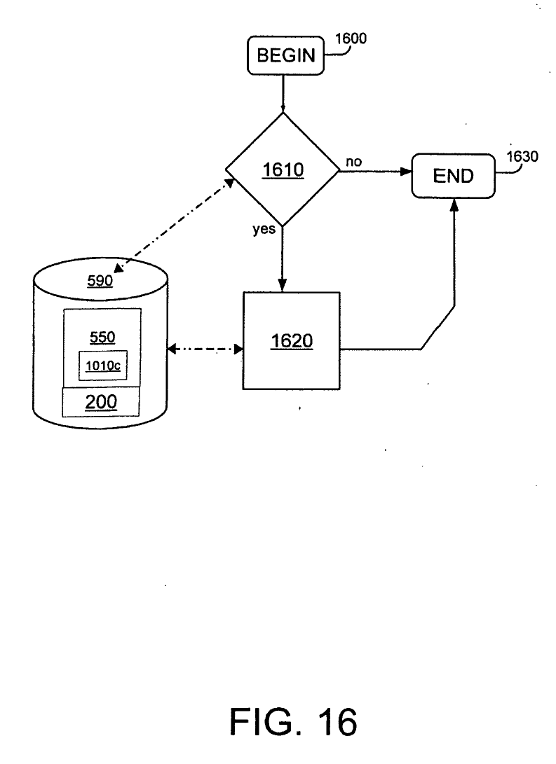

FIG. 16 provides a flow chart for a web-based front-end for one embodiment of a customized playlist “bumping” system. A playlist “bump” interface 1600 is activated by a system user activating a “bump” link 1090 as described above in FIG. 10. Upon activating the “bump” link 1090, the “bump” interface performs a “bump” check query 1610 to determine whether that system user has already “bumped” the particular playlist. If the system user has already “bumped” the particular playlist, the playlist “bump” interface 1600 ends 1620. If the system user has not yet “bumped” the particular playlist, then the “bump” value 1010c (see FIG. 10) for the playlist is incremented by one. The “bump” interface then ends 1620. The same “bump” process can advantageously be applied to individual songs, artists, system users, categories, and the like.

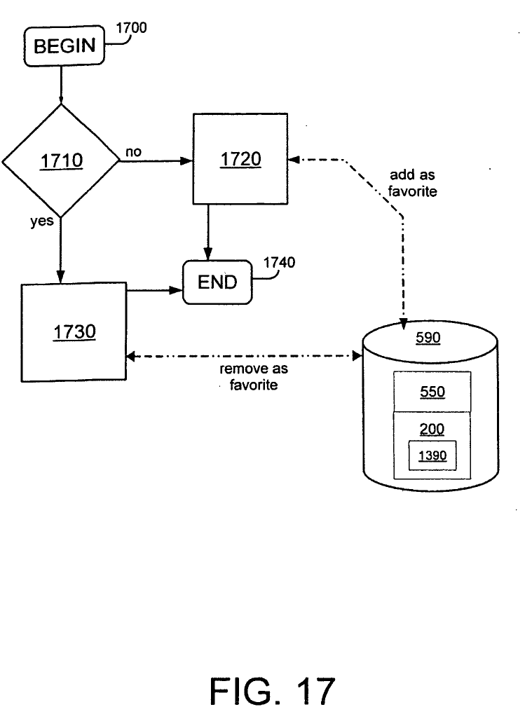

FIG. 17 provides a flow chart for a web-based front-end for one embodiment of a customized playlist “starring” system. A playlist “star” interface 1700 begins when a registered system user activates a “star” button 1015 (see FIG. 10) associated with a particular playlist. Upon activating the “star” button 1015, the playlist “star” interface determines whether that playlist is part of that system user's favorite playlists list 1370 (see FIG. 13) via a “star” query step 1710. If the playlist is not currently on the system user's favorite playlists list 1370, then in an add playlist step 1720 the playlist is added to the favorite playlists list 1370. If the playlist is currently on the system user's favorite playlists list 1370, then in a remove playlist step 1730 the playlist is removed from the favorite playlists list 1370. The process then ends 1740. The same “star” process can advantageously be applied to individual songs, artists, system users, categories, and the like.

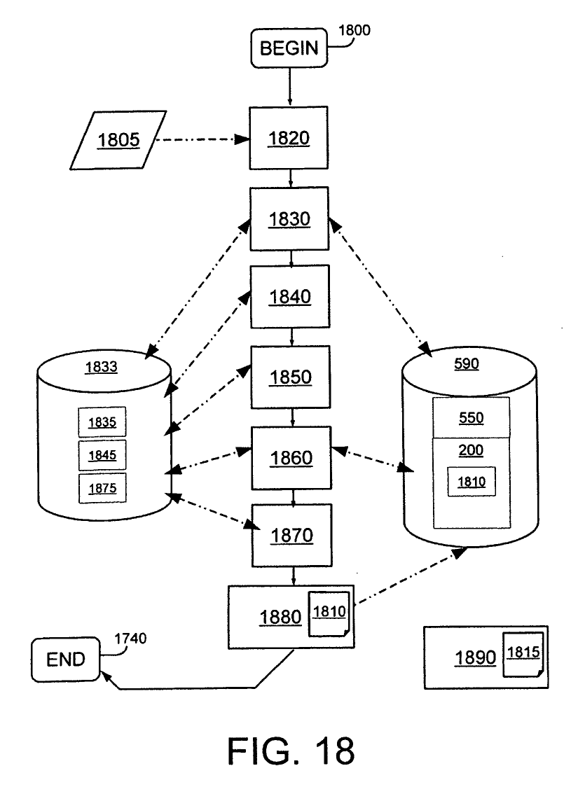

FIG. 18 provides a flow chart for a web-based embodiment of a customized playlist recommendation system wherein recommendations are provided by artist. In association with a system user custom page as described in FIGS. 13 & 14, upon selection of a particular artist 1805, a list of recommended artist links 1810 are provided via an artist recommendation interface 1820. The artist recommendation interface 1820, in one embodiment, provides a nine step process for determining other recommended artists:
(1) via a playlist database traversal block 1830, find every playlist with artist 1805 and store the resulting playlists in temporary metaplaylist 1835;
(2) via an artist listing block 1840, list every artist that appears in each playlist in the temporary metaplaylist 1835 in a temporary artist list 1845;
(3) via an artist histogram block 1850, for each artist in the temporary artist list 1845, add one point for each playlist in the temporary metaplaylist 1835 where that artist appears (multiple appearances of the same artist in a playlist are still only counted once);
(4) via a system user traversal block 1860, list every artist that appears as that system user's “starred” artists in the system user data 200, and add 1.5 points for each “starred” artist;
(5) via a recommendation selection block 1870, add the points from steps (3) and (4) for each artist, and output a predetermined number of artists with the highest number of total points to a final recommended artist list 1875; and,
(6) via a recommendation output block 1880, output the final recommended artist list 1875 to a set of recommended artist links 1810 to appear in, for example, the system user custom status page 1300 described previously.

The same ranking process can advantageously be applied to individual songs, playlists, system users, categories, and the like. For example, for a customized playlist recommendation system wherein recommendations are provided by starred media file, simply substitute song name for artist in steps (1)-(3), and modify steps (4) through (6) as follows:
(4a) via a system user traversal block 1860, list every song that appears as that system user's “starred” song in the system user data 200, and add 1.5 points for each “starred” song;
(5a) via a recommendation selection block 1870, add the points from steps (3) and (4) for each song, and output a predetermined number of songs with the highest number of total points to a final recommended songs list 1885; and
(6a) via a playlist search block (in a position analogous to block 1880), output the playlists that most closely match the final recommended songs list 1885 to a set of recommended playlist links 1815 (handled analogously to links 1810) to appear in, for example, the system user custom status page 1300 described previously.

In another recommendation process, artists can be recommended for a particular system user simply based on star ratings:
(1) using the process of FIG. 18, determine the top five recommended artists for each artist marked as “starred” by a member;
(2) keep a count of the total number of recommendations obtained in step (1) for each artist, and add them for each artist (multiple recommendations for a particular artist may be counted multiple times);
(3) select a predetermined number of artists with the highest counts of recommendations as summed in step (2), and provide them via a set of links to the system user via the system user's custom page.

As with before, the same process can be used for songs, users, playlists, and other media information types.

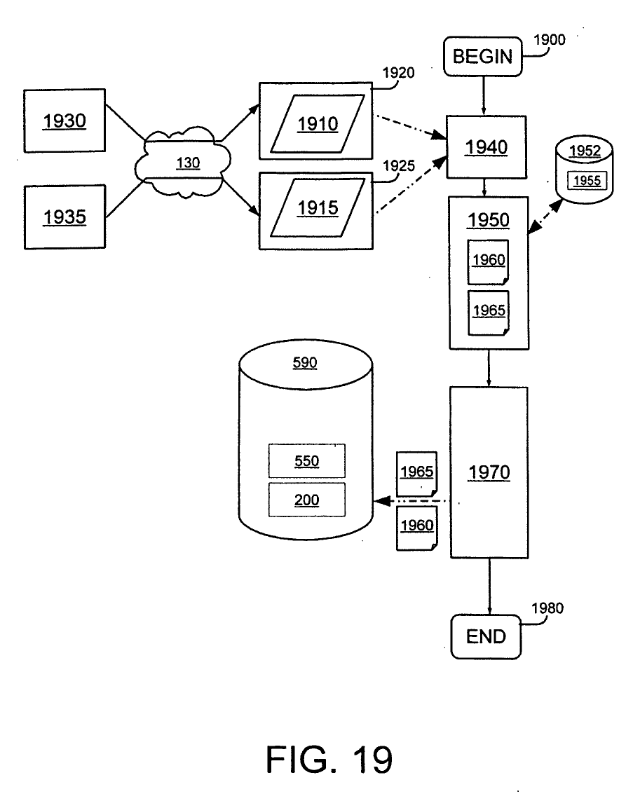

FIG. 19 provides a flow chart for a web-based embodiment of a customized playlist interoperability system. When a user uploads a playlist via the mechanism of FIG. 5, and reaches the conversion block 540, or shares playlists with other users who may use other third party music providers, the playlists may not be of a compatible format. A playlist interoperability interface 1900 takes as input a first playlist 1910 and a second playlist 1915. The first playlist 1910 is received via a predetermined electronic mail message format 1920 from a third party music provider 1930. The second playlist 1915 is automatically uploaded via the automatic playlist upload interface 200 of FIGS. 2 and 5 by a system user and is in a format 1925 predetermined by another third party music provider 1935.

A recognition block 1940 associates the first playlist 1910 with its format 1920, and associates the second playlist 1915 with its format 1925. Then, a translation block 1950 translates the first playlist from its native format 1920 to a standard format 1955, to create a first standard playlist 1960, and the translation block 1950 translates the second playlist from its native format 1925 to a standard format 1955, to create a second standard playlist 1965. Finally, a storage block 1970 stores the first standard playlist 1960 and second standard playlist 1965 in the main playlist database 590 for use in the playlist sharing system, data analysis, and sharing between system users. Finally, the interoperability interface ends 1980.

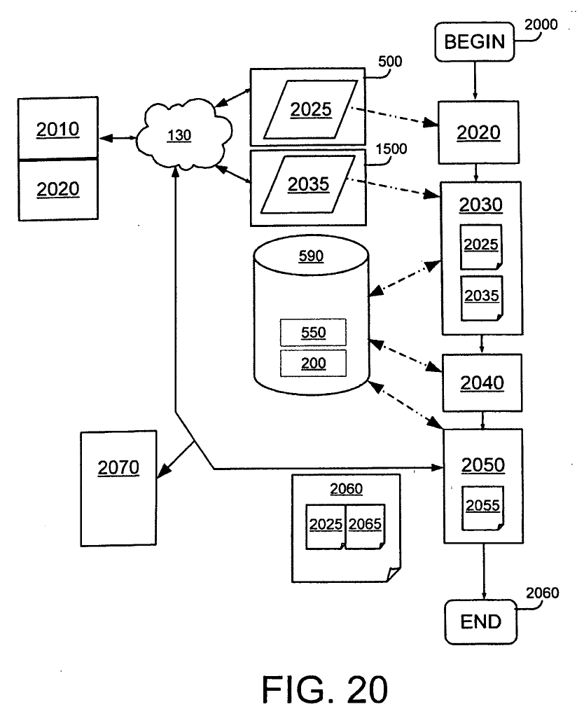

FIG. 20 provides a flow chart for a web-based embodiment of a customized playlist toolbar creation and affiliate system. A playlist toolbar creation interface begins 2000 when it is accessed by a system user 2010 with an external website 2020 outside of the playlist sharing system. In a playlist selection block 2020, the system user selects one or more playlists 2025 to appear in the toolbar, and may upload and create playlists, along with titles, descriptions and categories for the playlists, through the procedures described in FIGS. 2-5. If the system user 2010 has an affiliate relationship information 2035 for use with one or more third party music stores 1550, as described previously, then a toolbar affiliate third party music store selection block 2030 permits the system user to select third party music stores that can appear in the toolbar, and to enter the affiliate information or affiliate code for use with the meta-affiliate system for these third party music stores similar to the playlist meta-affiliate interface described in FIG. 15. Thus this toolbar meta-affiliate system, like the playlist meta-affiliate system previously described, permits the sharing of affiliate income between system users and third party media providers via media toolbars created via the toolbar creation and affiliate system and served by the playlist server directly or indirectly to third party websites. In a toolbar options block 2040, the system user selects design and interface options for the toolbar. Then, a toolbar code creation block 2050 creates a toolbar code string 2055 which is provided to the system user 2010 to place on the system user's external website 2020.

Once the system user 2010 places the toolbar code string 2055 on the system user's external website 2020, executing the toolbar code string 2055 on the system user's external website 2020 causes a network request from the external website 2020 to the playlist toolbar creation interface 2000 to return a toolbar page 2060 to the requesting external website 2020. The toolbar page 2060 advantageously includes linked playlists 2025 (including, for example, playlist name, song name, artist name, and links to one or more third party music stores, as previously described), and advantageously further includes toolbar usage data 2065. The toolbar usage data 2065 permits the toolbar creation interface 2000 to keep track of what songs are being selected from different external websites 2020 owned by different system users 2010, for usage tracking and tracking of meta-affiliate data. Advantageously, the toolbar usage data 2065 also permits customized advertisements to be served to individual toolbars on external websites 2020 based on songs in the playlists 2025, songs people click, and playlist title and description, among other data points. Finally, a toolbar management block 2070 permits system user to edit, view, and delete toolbars and third party music store affiliate codes.

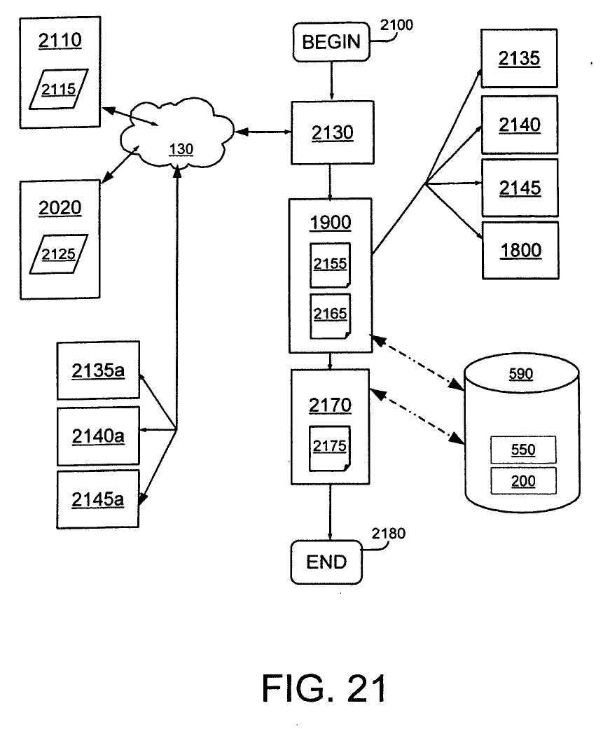

FIG. 21 provides a flow chart for a web-based embodiment of a social network schema based on sharing of playlists. A social network interface 2100 includes a first system user 2110 with a first playlist 2115 and a second system user 2120 with a second playlist 2125. A social network block 2130 includes links to discussion forums 2135, weblogs 2140, e-mail interface 2145, and playlist/artist/song recommendations based on system recommendation algorithms described above with respect to FIG. 18. The social networking schema also permits system users to find and select other system users as friends. The discussion forums, weblogs, and e-mail interface may be internal to the playlist sharing system or may be external, independent discussion forums 2135a, weblogs 2140a, or e-mail interfaces 2145a through which playlist sharing and discussions are made interoperable via the present system.

Independently, system users can submit playlists, comments, or, in one embodiment, both playlists and comments, to any number of “topics,” whereby groups of system users can share playlists related to a particular topic with or without parallel discussions of the topic. For topics, as well as other social networking schema, the system user can limit the group of system users to a particular group of pre-selected “friends,” or the group of system users can be open to all.

In order for the first system user 2110 and second system user 2120 to share their respective playlists 2115 and 2125, even if they use different software or different third party music providers that employ different playlist formats, a playlist interoperability interface 1900 (as shown in FIG. 19) converts the first playlist 2115 and second playlist 2125 to a first standard playlist 2155 and second standard playlist 2165. Once converted, the first system user 2110 and second system user 2120 can freely exchange their playlists via e-mail, weblogs, discussion forums, and the like with universal access to each other's playlists. In its simplest form, for example, the first system user 2110 can, after conversion via the playlist interoperability interface 1900, email 2145 the first standard playlist 2155 to the second system user 2120. Because of the standard format of the first standard playlist, the second system user 2120 can interact with the first standard playlist 2155 regardless of what third party music source the second system user 2120 uses.

In addition, a friends interface block 2170 permits a system user to invite another system user or any person at a valid e-mail address to join the system user's “friends” group, if the person accepts the e-mail invitation. Once a person is on a system user's set of friends 2175, a system user can select to see all playlists in the playlist sharing systems or can select to only see those playlists created by those in the user's set of friends. Thus, optionally in one embodiment, a system user can post messages to selected friends via the weblogs 2140 (via an internal weblog, forum or BBS system or via any of the many well known external weblog scripts and/or services, such as, for example, Blogger® or TypePad®, or another network protocol including but not limited to instant messaging protocols, SMS (short messaging service), SMTP (simple mail transfer protocol), HTTP, among others), or via e-mail 2145 to the set of friends 2175, and so on. When submitting a playlist, a user can choose whether the playlist is available to everyone or just those members on the user's FIQL friends list. System users who have common music interests often have other data points in common. When a system user sees a playlist that interests that user, the system user can easily view the contributing system user's profile, other playlists by this system user, and save this system user to the personalized “MyFIQL” area, if the system user is registered. In this manner, registered system users can see what other system users are saving their playlists to their MyFIQL areas. Optionally, e-mail addresses, instant messaging names, users that have been selected as FIQL friends and their playlists, and/or discussion forums are provided for discussions between system users

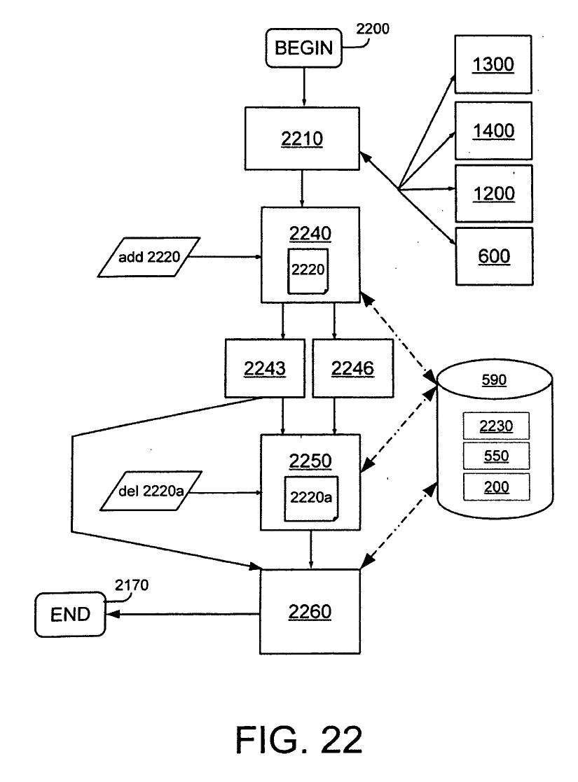

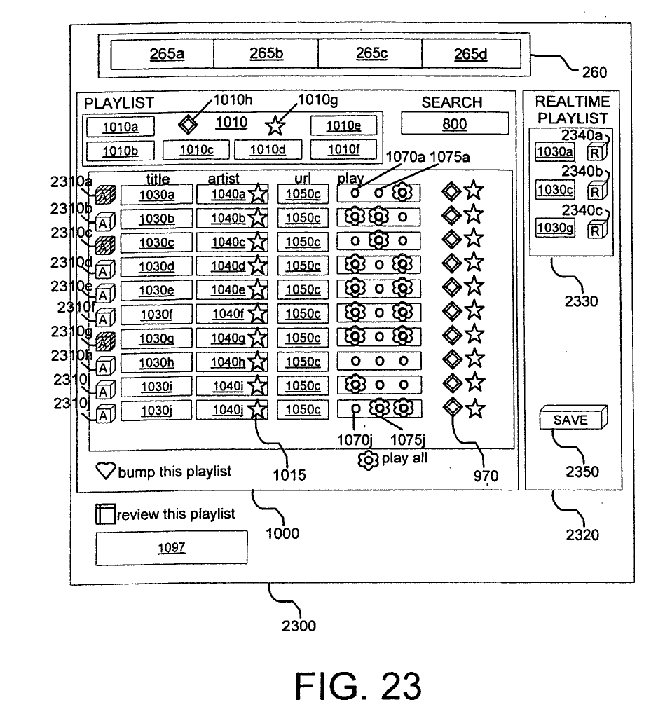

FIG. 22 provides a flow chart for a web-based embodiment of a real time playlist creator. A real time playlist interface 2200 maintains a link to any present interface screen 2210 in the playlist sharing system, such as previously described screens 600, 1200, 1300, or 1400, for example and without limitation. Upon selection of a song 2220 for inclusion in a real time playlist 2230 via a song selection gesture 2240 (see FIG. 23 for an example), the song 2220 is added to the real time playlist 2230. The real time playlist 2230 is displayed on a real time playlist interface screen 2243 accessible via a menu item, or, alternatively, it can be displayed via a “side-bar” column 2246 showing the real time playlist displayed alongside another interface screen 2210, as shown in FIG. 23. In either case, the real time playlist interface screen 2246 further includes a song deletion gesture 2250 which, when performed on the real time playlist interface screen 2246, removes the selected song from the real time playlist 2230. In addition, the real time playlist interface screen 2246 includes a playlist saving gesture 2260 which, when performed on the real time playlist interface screen 2240 (such as, for example, clicking on a “SAVE” button as shown on FIG. 23), saves the real time playlist to the system user's permanent set of created playlists as shown in FIG. 13. Optionally, the system user may be directed to the playlist description screen of FIG. 4 prior to saving the new playlist to the system user's permanent set of created playlists.

FIG. 23 provides a representational view of a web-based embodiment of a real time playlist creator. A real-time playlist creator screen 2300, in one embodiment, includes a plurality of song selection links 2310a-j and a real-time playlist sidebar 2320 on which is displayed a real time playlist 2330. The song selection links 2310a-j, as with any other links in the present system, can be hyperlinks, selection buttons, other selection widgets, or for further example can be drop-down menu items associated with the song to be selected. Alternatively, the real time playlist 2330 can be available on a separate real time playlist screen via a submenu 265a-d on the menu 260 on any screen of the playlist sharing system. As a system user traverses the various interface screens of the playlist sharing system, the system user can select a song selection link 2310a to interactively add a particular song to the real-time playlist 2330. The real time playlist sidebar 2320 updates itself upon the addition of a song via a song selection link 2310a to include the new song. The real time playlist sidebar 2320 also includes a plurality of song removal links 2340a-c for removing songs from the real time playlist. In FIG. 23, for example, song selection buttons 2310a, 2310c and 2310g have been selected, thus putting songs titles 1030a, 1030c and 1030g in the real-time playlist 2330. The real time playlist sidebar also includes a playlist save button 2350 which permits the real time playlist to be saved to the system user's set of playlists via, for example, the playlist description interface of FIG. 4.

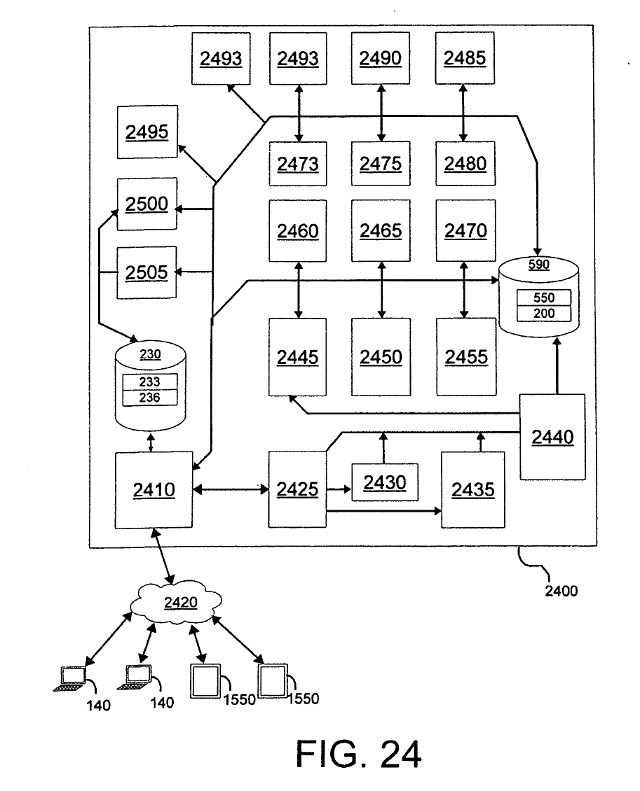

FIG. 24 provides a schematic view of one embodiment of a network-based playlist sharing system. In a descriptive form, one embodiment of the playlist sharing system 2400 includes a web interface module 2410 for serving web pages showing the various screens of the playlist sharing system to system users over a network 2420, where each interface is directly or indirectly accessible via web page links and is linked to a standard database 230 of web pages 233 and scripts 236, as well as the main playlist database 590 including playlists 550 and system user data 200. For submitting playlists to the playlist sharing system 2400, a playlist submission interface 2425 (FIG. 5), including an automatic playlist submission process 2430 (FIG. 2) and a manual playlist submission interface 2435 (FIG. 3) are provided, along with a playlist description interface 2440 (FIG. 4). A playlist browsing interface 2445 (FIGS. 6, 7) is provided for viewing and navigating playlists based on playlist category, genre, artist, song, system user, and the like. A playlist searching interface 2450 (FIG. 8) is provided for finding playlists based on artist, song, title, system user, and the like. A playlist ranking interface 2455 (FIG. 9) is also provided for ordering playlists for display based on playlist popularity. A third party ordering interface 2460 (FIG. 10) is provided for linking third party services that provide a particular media work automatically for each item in a playlist, and a single gesture playlist playback interface 2465 (FIG. 11) is provided to play back some or all media works on a playlist from one or more third party services. A system user can receive meta-affiliate credit for media works ordered from their playlist via a meta-affiliate interface 2470 (FIG. 15). A system user registration interface 2473 (FIG. 12) provides basic information on system user data and associates a system user with a customized system user status interface 2475 as well as association of a system user with third party affiliate information (FIGS. 13-14).

A playlist “bumping” interface 2480 (FIG. 16) provides a procedure for system users to directly and simply rank playlists, and a playlist “starring” interface 2485 (FIG. 17) provides a procedure for system users to select favorite playlists. Reciprocally, a playlist/artist recommendation interface 2490 (FIG. 18) provides algorithmic recommendations for a system user based on artist. A system user can create, save and edit real time playlists via a real time playlist interface 2493 (FIGS. 22-23).

Finally, a universal playlist interoperability interface 2495 (FIG. 19) is provided to convert disparate playlist formats used by various third party music providers to a standard playlist format, from which a social network interface 2500 (FIG. 21) can be employed to share standard playlist format information via standard internet communication forms such as weblog, e-mail, instant messaging, discussion forum, and the like (not shown, see FIG. 21). Similarly, a playlist toolbar interface 2505 (FIG. 20) can be created to share playlists on third party websites by way a toolbar served from the playlist sharing system to the third party website, including system user and meta-affiliate information.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

APPENDIX I
Playlist Conversion Codes (WinAmp, WMP)

```
$count=0;
while ($line=fgets($fd,300)){ // for each LINE in the file
    if($Ext==‘pls’ || $Ext==‘b4s’){ // mp3 winamp 3.0
        if($count<$NUM_PROCESS_SONGS){
    preg_match(“/<Name>(.*?)<\/Name>/”,$line,$match);
            if(sizeof($match)==2){//got the match, so save it
                array_push($entries,$match[1]);
                $count++;
            }
        }
    }elseif($Ext==‘m3u’){ // mp3 winamp 5.0
        // #EXTINF:242,Coldplay - Such a Rush
        if($count<$NUM_PROCESS_SONGS){
            preg_match(“/[0-9],(.*?)\n/”,$line,$match);
            if(sizeof($match)==2){//got the match, so save it
                array_push($entries,$match[1]);
                $count++;
            }
        }
    } elseif($Ext==‘wpl’){ // WMP new extension
        if($count<$NUM_PROCESS_SONGS){
          preg_match(“/media src=\“(.*?).mp3\”\/\>/i”,$line,$match);
          if(sizeof($match)==2){//got the match, so save it
                array_push($entries,basename($match[1]));
                $count++;
            }
        }
    } elseif($Ext==‘asx’){ // WMP
        if($count<$NUM_PROCESS_SONGS){
            preg_match(“/\“SourceURL\” Value = \“(.*?).mp3\”
\/\>/i”,$line,$match);
            if(sizeof($match)==2){//got the match, so save it
                array_push($entries,basename($match[1]));
                $count++;
            }
        }
    }
```

APPENDIX II
XMP Playlist Conversion (iTunes)

```
class itunes_parser{
    var $xml_parser;
    var $xml_current;
    var $xml_key;
    var $xml_song;
    var $title_key;
    var $scounter=0;
    var $playlist=array( );
    function xml_start($xml_parser,$xml_tag,$xml_attributes){
        $this->xml_current.=“/˜”.$xml_tag;
    }
    function xml_end($xml_parser,$xml_tag){
        $xml_caret_pos=strrpos($this->xml_current,“/˜”);
        $this->xml_current=substr($this->xml_current,0,
        $xml_caret_pos);
    }
    function xml_data($xml_parser,$xml_data){
        switch($this->xml_current){
            case“/˜PLIST/˜DICT/˜DICT/˜DICT/˜KEY”:
                $this->xml_key=$xml_data;
                break;
            case“/˜PLIST/˜DICT/˜DICT/˜DICT/˜STRING”:
                switch($this->xml_key){
                    case“Name”:
                        $this->xml_song=$xml_data;
                        break;
                    case“Artist”:
                        $this->playlist[$this-
>scounter]=$xml_data.“ - ”.htmlentities($this->xml_song);
                        $this->scounter++;
                        break;
                    default:
                        break;
                }
                break;
            default:
                break;
        }
    }
    function parser($itunes_file){
        $this->xml_parser=xml_parser_create( );
        xml_set_object($this->xml_parser,$this);
        xml_set_element_handler($this->xml_parser,
        “xml_start”,“xml_end”);
        xml_set_character_data_handler($this->xml_parser,
        “xml_data”);
        $xml_file=fopen($itunes_file,“r”);
        $xml_data=fread($xml_file,filesize($itunes_file));
        xml_parse($this->xml_parser,$xml_data,feof($xml_file));
    }
}
```

APPENDIX III
Playlist Ranking Code

```
S> - code for playlist rankings
/////////////////////////////////////////////////////////////////////////////
// update the static rating value (used in search)
// Playlist rating is the average of user reviews (DISTINCT users)
$query=“select DISTINCT username,rate from reviews where status=1
AND plid=”.$row[‘plid’];
$result= mysql_query($query) or die(“Query failed: $query”);
unset($playlist_ratings);
while($row2 = mysql_fetch_array($result, MYSQL_ASSOC)){
        $playlist_ratings[ ]=$row2[‘rate’];
}
if(is_array($playlist_ratings)){
        $playlist_rating =
number_format(array_sum($playlist_ratings) /
count($playlist_ratings),2);
}else{
        $playlist_rating=0;
}
// update the value
$query=“UPDATE playlists SET rating=“.$playlist_rating.” WHERE
status=1 AND id=”.$row[‘plid’];
mysql_query($query) or die(“Query failed: $query”);
//////////////////////////////////////////////////////////////////////////////
```

APPENDIX IV
Member Ranking Code and Points System

```
S> - code for member rankings (and point system)
//////////////////////////////////////////////////////////////////////////////
//::URS User Rating System Piece
// get the corresponding plid's for all review ids
$query=“SELECT DISTINCT playlists.id FROM reviews,playlists WHERE
reviews.plid=playlists.id AND reviews.id IN ($approved_ids)”;
$result=mysql_query($query) or die(“Query failed: $query”);
while ($row = mysql_fetch_array($result, MYSQL_ASSOC)){
        $plids[ ]=$row[‘id’];
}
$plids=implode(‘,’,$plids);
$query=“SELECT playlists.username,plid,count(*) AS num,avg(rate) AS
average_rating FROM reviews,playlists WHERE reviews.plid=playlists.id AND
reviews.status=1 AND reviews.plid IN (“.$plids.”) GROUP BY plid”;
$result=mysql_query($query) or die(“Query failed: $query”);
// loop through all users whose playlist reviews we are approving and award
points where needed
while($row = mysql_fetch_array($result, MYSQL_ASSOC)){
        if($row[‘num’]%19==0){
                // we are about to hit 20,40,60 ect approved reviews now
                if(floor($row[‘average_rating’])==10){
                        // if the average playlist review rating is 10, award 100
                        points to the user
                        $query=“UPDATE users SET rating=rating+100 WHERE
username=‘“.$row[‘username’].”’”;
                                  if(!mysql_query($query)){$msg=“Query failed:
$query”;echo $msg;exit( );}
}
                          elseif(floor($row[‘average_rating’])==9){ // if the average
playlist review rating is 9, award 80 points to the user
                                  $query=“UPDATE users SET rating=rating+80 WHERE
username=‘“.$row[‘username’].”’”;
                                  if(!mysql_query($query)){$msg=“Query failed:
$query”;echo $msg;exit( );}
                        }elseif(floor($row[‘average_rating’])==8){ // if the
average playlist review rating is 8, award 70 points to the user
                                $query=“UPDATE users SET rating=rating+70 WHERE
username=‘“.$row[‘username’].”’”;
                                if(!mysql_query($query)){$msg=“Query failed:
$query”;echo $msg;exit( );}
                        }elseif(floor($row[‘average_rating’])==7){ // if the
average playlist review rating is 7, award 60 points to the user
                                  $query=“UPDATE users SET rating=rating+60 WHERE
username=‘“.$row[‘username’].”’”;
                                  if(!mysql_query($query)){$msg=“Query failed:
$query”;echo $msg;exit( );}
                  }
          }
                  //::end URS User Rating System Piece
//////////////////////////////////////////////////////////////////////////////
```

1. A universal playlist sharing system for sharing playlists including a plurality of media works, comprising:
a server coupled by a network to a plurality of server users, the server including:
a first playlist submission module for converting a first playlist in a first proprietary format submitted by a first server user over the network via a first network protocol to a standard playlist format;
a second playlist submission module for converting a second playlist in a second proprietary format submitted by a second server user over the network via a second network protocol to a standard playlist format;
a playlist browsing interface module enabling the first user and the second user to share the first playlist and the second playlist in the standard playlist format over the network; and
a playlist searching interface module enabling the first user and the second user to share the first playlist and the second playlist in the standard playlist format over the network.

2. The system of claim 1, wherein the server further comprises:
a universal media playback module for playing back the standard format playlists, the universal media playback server including:
a third party source locator module for associating each of the media files in the playlist with one or more links to third party locations for obtaining the media files when such locations exist;
a playback initiator module for initiating playback of the playlist; and
a playback interface module which executes playback of each media file in the playlist according to the link provided by the third party source locator.

3. The system of claim 2, further comprising:
an affiliate database storing associations between the first user, a first playlist submitted by the first user, the sharing server, and a third party location for obtaining media files from the first playlist; and
wherein the server further includes an affiliate updater module for associating a credit from the third party location to the first user upon activation of the link provided by the third party source locator to a media file in the first playlist by a second user based on the associations between the first user, a first playlist submitted by the first user, and a third party location for obtaining media files from the first playlist.

4. The system of claim 2, wherein the playback initiator module initiates playback of the media files in the playlist upon receipt of a single user interface gesture from a system user over the network.

5. The system of claim 3, wherein the server further includes a social networking playlist module, including:
a user invitation interface module for a first system user to invite other system users to share a set of playlists each containing a plurality of media files in any of a plurality of playlist formats over the network;
a playlist sharing interface module for sharing the set of playlists in the standard playlist format via the playlist submission module wherein the playlist sharing interface includes security controls for limiting playlist access to a predetermined set of designated users; and
a network communication interface module for direct communication between the first server user and other server users associated with the shared set of playlists.

6. The system of claim 1, wherein the server further includes a social networking playlist module, including:
a user invitation interface module for a first system user to invite other system users to share a set of playlists each containing a plurality of media files in any of a plurality of playlist formats over the network;
a playlist sharing interface module for sharing the set of playlists in the standard playlist format via the playlist submission module wherein the playlist sharing interface includes security controls for limiting playlist access to a predetermined set of designated users; and
a network communication interface module for direct communication between the first server user and other server users associated with the shared set of playlists.

7. The system of claim 1, wherein the server further includes a real time playlist module, the real-time playlist module comprising:
a media file selector module for enabling a first system user to interactively select media files from a at least one of the server-based playlist browsing interface module and the server-based playlist searching interface module for inclusion in a real time playlist;
a playlist manager interface module for enabling the first system user to edit, delete or add media files and information to the real time playlist; and
a playlist storage interface module for converting the real time playlist to a stored playlist associated with the first system user in the playlist sharing system.

8. A community media playlist relational database system, comprising:
a playlist server in communication with a database of media playlists, the media playlists each including media identification information and user identification information, the at least one playlist server connected to a network for access thereto by a plurality of system users;
wherein the playlist server includes a server-provided network playlist interface module providing a front-end to the playlist server over the network, the network playlist interface module including:
a playlist submission interface module for submitting media playlists to the playlist server by a system user over a network from a plurality of external media playlist formats, the playlist server recognizing the plurality of external formats and converting the submitted media playlists for inclusion in the database of media playlists;
a playlist linking interface module for linking the database of media playlists to additional media information through the network playlist interface module, the playlist linking interface module further linking the database of media playlists to a plurality of points of purchase for individual media items in the media playlists of the database of media playlists; and
a meta-affiliate interface module for distributing affiliate profits from at least one of the plurality of points of purchase when accessed via the playlist linking interface module to distribute at least a portion of the affiliate profits among at least one of the system users based upon media identification information, system user information, and playlist information.

9. The system of claim 8, wherein the playlist server further includes:
a playlist search interface module capable of at least one of searching and browsing the database of media playlists to return similar playlists or system users, based on similarity of one or more of the following inputs from a system user: media identification information, media category information, media relation information, user information, or matching of a plurality of media items on respective playlists;
a playlist rating interface module for rating the database of media playlists based on the summation of a number of rankings submitted by system users; and
a recommendation interface module for returning lists of recommended items including at least one of playlists, media identification information, media category information, media relation information, and user information from the playlist database to system users based on an association between a playlist selected by a system user, the results of the playlist rating interface module, and the results of the playlist search interface module.

10. The system of claim 9, wherein the playlist server further comprises:
a social networking interface module for enabling network communications between system users on the playlist network based upon one or more of the following: media identification information, media category information, media relation information, user information, or matching of a plurality of media items on respective playlists.

11. The system of claim 8, wherein the playlist server further comprises:
a social networking interface module for enabling network communications between system users on the playlist network based upon one or more of the following: media identification information, media category information, media relation information, user information, or matching of a plurality of media items on respective playlists.

12. The system of claim 8, wherein the playlist server further comprises:
a real time playlist interface module for interactively building a new playlist from the playlist search interface module.

13. The system of claim 8, wherein the playlist server further comprises:
a playlist toolbar interface module for creating and serving web page code to a third party server over the network representing at least one playlist including an association between the playlist and the playlist linking interface module.

14. A media playlist sharing system, comprising:
a web interface module for serving elements of a playlist sharing system to system users over a network from a playlist sharing server;
the playlist sharing server including access to a first playlist and a second playlist, the first playlist including a first playlist name, a first set of media descriptors representing a first set of media works, and first playlist description data, and the second playlist including a second playlist name, a second set of media descriptors representing a second set of media works, and second playlist description data; and
wherein the playlist server includes:
a playlist submission interface module, including an automatic playlist submission interface module providing:
a server-based universal playlist compatibility interface to populate the first playlist from any of a plurality of third party playlist formats, and a server-based manual playlist submission interface for populating the second playlist via the web interface module;
a media recommendations interface to provide recommendations of at least one of playlists, media works, and system users based on an affinity at the playlist server of at least one of playlists, media works, and system users; and
a social networking interface module for enabling a first system user and a second system user to directly communicate with one another and share standard playlist format information via a network communication protocol.

15. The system of claim 14, wherein the playlist server further comprises:
a third party ordering interface module for associating with each media descriptor, representing a media work, a link to each of a plurality of third parties from which a link to obtain the media work is available;
a user registration interface module for populating a first system user account and a second system user account with first user data and second user data respectively, and associating a first playlist with the first system user account and a second playlist with the second system user account, and associating a first system user account with affiliate data for at least one of the third parties from which a link to obtain at least one media work from the first playlist associated with the first system user account; and
a playlist meta-affiliate interface module for crediting purchases of media works from the first playlist via the link to third party ordering interface with the first system user account according to the affiliate data associated with the first system user account.

16. The system of claim 15, wherein the playlist server further comprises:
a playlist browsing interface for viewing and navigating playlists in the web interface module based on playlist name, playlist media descriptors, and playlist data;
a playlist searching interface for finding playlists via the web interface based on playlist name, playlist media descriptors, and playlist data;
a playlist ranking interface for ordering playlists for display based on playlist popularity as determined by system users; and
a playlist recommendation interface for providing algorithmic recommendations for a first system user account and a first playlist.

17. The system of claim 14, wherein the playlist server further comprises:
a playlist browsing interface module for viewing and navigating playlists in the web interface module based on playlist name, playlist media descriptors, and playlist data;
a playlist searching interface module for finding playlists via the web interface module based on playlist name, playlist media descriptors, and playlist data;
a playlist ranking interface module for ordering playlists for display based on bumping of playlists by system users; and
a playlist recommendation interface module for providing algorithmic recommendations for a first system user account and a first playlist.

18. The system of claim 16, wherein the playlist server further comprises:
a playlist toolbar interface module for sharing playlists on a third party website independently of the playlist browsing interface module by way a toolbar served from the playlist sharing system to the third party website upon placement of toolbar code on the third party website; and,
a toolbar meta-affiliate interface module for crediting purchases of media works from the toolbar via the link to third party ordering interface with the first system user account according to the affiliate data associated with the first system user account.

19. The system of claim 16, wherein the playlist server further comprises:
a real time playlist interface module for creating, editing and deleting a third playlist in real time interactively in the playlist browsing interface module.

20. A computer readable medium storing a computer program for causing a processor, used in a data processing system controlling a media playlist sharing system, to:
supply a web-based interface to a network including a plurality of system users;
provide an interface for uploading media playlists from the plurality of system users to the media playlist sharing system;
associate the playlists to respective system users;
associate the playlists to one or more third party providers for each of the media items on the playlists;
enable the sharing of the media playlists among the plurality of system users via the web-based interface;
provide network communications among the plurality of users via the web-based interface according to the content of the playlists associated with respective system users;
store affiliate associations between the system users and the third party providers; and
track the stored affiliate associations of each media item on the playlist associated with a user when that media item is selected for acquisition from a third party by another user.

21. The computer readable medium of claim 20, wherein the program further causes the processor to:
generate real time playlists based on the web-based interface to the means for sharing the media playlists.

22. The computer readable medium of claim 20, wherein the program further causes the processor to:
generate a playlist toolbar on a third party server over the network of the plurality of system users, the playlist toolbar associating the playlists to one or more third party providers for each of the media items on the playlists.

23. A method for sharing media playlists including a plurality of media files among a plurality of users on a network, comprising:
uploading a first playlist from a first user to a playlist sharing server over the network, the playlist sharing server including a database, a web server, and an interface to a network including the plurality of users;
uploading a second playlist from a second user to the playlist sharing server over the network;
converting the first playlist and the second playlist to a standard playlist format on the playlist sharing server;
storing the first playlist and the second playlist in the standard playlist format in the database associated with the playlist sharing server;
associating the first playlist and the second playlist with respective media identification information, media relation information, and user information for each the playlist in the database;
associating the first playlist and the second playlist with a plurality of third party media providers such that each media file in the first playlist is linked to at least one of the plurality of third party media providers that distributes that media file if any, and each media file in the second playlist is linked to at least one of the plurality of third party media providers that distributes that media file if any; and
sharing the first playlist and the second playlist with the first user and the second user via the web interface over the network.

24. The method of claim 23, further comprising socially networking the first user and the second user via the web interface to permit the first user and the second user to directly communicate via a network communication protocol over the network to share a plurality of playlists based upon a particular “topic” to which the plurality of playlists relate.

25. The method of claim 23, further comprising
associating the first playlist with the first user;
associating the first user with the at least one of the third party media providers as an affiliate; and
distributing affiliate income to the first user upon the second user obtaining a media file in the first playlist from the at least one of the third party media providers via the first playlist.

26. The method of claim 23, further comprising creating a web toolbar associated with the first playlist and the first user;
providing a toolbar code to the first user representing the web toolbar;
placing the toolbar code on a third party server coupled by the network to the network playlist server;
serving the web toolbar to the third party server from the network playlist server upon running the toolbar code on the third party server, such that the web toolbar displays the contents of the first playlist by way of the third party server.

27. The method of claim 26, further comprising
associating the web toolbar including a first playlist containing a plurality of media files with the first user;
associating the first user with the at least one of the third party media providers as an affiliate; and
distributing affiliate income to the first user upon the second user obtaining a media file in the first playlist from the at least one of the third party media providers via accessing the first playlist by way of the web toolbar on the third party server.

28. A method for universally sharing playlists of media works among a plurality of users on a network via a network playlist server, comprising:
submitting a first playlist in a first proprietary format from a first user to the network playlist server over the network;
converting the first playlist to a standard playlist format;
submitting a second playlist in a second proprietary format from a second user to the network playlist server over the network;
converting the second playlist to a standard playlist format;
providing a web-based browsing interface enabling the first user and the second user to share the first playlist and the second playlist in the standard playlist format over the network; and
providing a web-based searching interface enabling the first user and the second user to share the first playlist and the second playlist in the standard playlist format over the network.

29. A method for sharing playlists of media files in a community media playlist relational database system over a network, comprising:
connecting to a network at least one playlist server including a database of media playlists, the media playlists each including media identification information and user identification information, for access thereto by a plurality of system users over the network;
providing a network playlist interface for interaction between the playlist relational database system and the plurality of system users, including:
submitting media playlists to the playlist server by a system user over a network from a plurality of external media playlist formats, the playlist server recognizing the plurality of external formats and converting the submitted media playlists for inclusion in the database of media playlists, and
linking the database of media playlists to additional media information through the network playlist interface, the playlist linking system further linking the database of media playlists to a plurality of points of purchase for individual media items in the media playlists of the database of media playlists; and
distributing affiliate profits from at least one of the plurality of points of purchase when accessed via the playlist linking interface to distribute at least a portion of the affiliate profits among at least one of the system users based upon media identification information, system user information, and playlist information.

30. A method for sharing media playlists, including a first playlist and a second playlist, the first playlist including a first playlist name, a first set of media descriptors representing a first set of media works, and first playlist description data, comprising:
providing a playlist sharing server to a plurality of system users over a network;
receiving a first playlist from a first system user;
automatically translating the first playlist from the first user to a standard playlist format;
populating the first playlist name, first set of media descriptors, and first playlist description data based on the translated first playlist from the first user;
sharing playlist data from the first playlist in the standard playlist format to a plurality of system users over a network from the playlist sharing server; and
connecting the first user and another user via a server-based social networking interface to enable the first user and another user to directly communicate with one another via a network communication protocol mediated by the playlist sharing server, based on the sharing of the first playlist between the first user and another user.

31. The method of claim 30, further comprising:
associating with each media descriptor, representing a media work, a link to each of a plurality of third parties from which a link to obtain the media work is available;
populating first system user account data associated with the first user, and associating a first playlist with the first system user account data, and associating a first system user account data with affiliate data for at least one of the third parties from which a link to obtain at least one media work from the first playlist associated with the first system user account; and
crediting purchases of media works from the first playlist via the link to third party ordering interface to a first user associated with the first system user account and the affiliate data associated with the first system user account.

32. The method of claim 30, further comprising:
enabling navigation and viewing of playlists over the network based on playlist name, playlist media descriptors, and playlist data;
enabling searching for playlists via the network based on playlist name, playlist media descriptors, and playlist data;
ranking playlists for display ordering based on bumping of playlists by system users; and
recommending a second playlist to the first user over the network for a first system user account and a first playlist based on the relationship of the playlist media descriptors and playlist data with the second playlist.
